(19) United States
(12) Patent Application Publication
(10) Pub. No.: US 2025/0039731 A1
(43) Pub. Date: Jan. 30, 2025

(54) JOINT USE OF MULTIPLE WIRELESS RECEIVERS TO SUPPORT MORE DEMANDING DOWNLINK QUALITY-OF-SERVICE REQUIREMENTS

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Kallol Das, Waddinxveen (NL); Remco Litjens, Voorschoten (NL); Haibin Zhang, Voorburg (NL)

(21) Appl. No.: 18/715,474

(22) PCT Filed: Dec. 21, 2022
(86) PCT No.: PCT/EP2022/087339

§ 371 Date: May 31, 2024

(30) Foreign Application Priority Data
Dec. 23, 2021 (EP) 212175327

(51) Int. Cl. H04W 28/02; H04B 7/06; H04L 5/00; H04W 76/15

(52) U.S. Cl. CPC H04W 28/0268; H04B 7/0626; H04L 5/0048; H04W 28/0215; H04W 76/15

(57) ABSTRACT

A method includes determining (401) information relating to each of a plurality of devices and transmitting (403) the information to cause a data flow to be requested with one or more quality-of-service requirements and the admittance of the data flow with the one or more quality-of-service requirements to be decided upon based on the information. The plurality of devices includes a first device which includes a first wireless receiver and a second device which includes a second wireless receiver. The method further comprises obtaining (405) a first signal received by the first wireless receiver over a data radio bearer associated with the data flow, obtaining (407) a second signal received by the second wireless receiver over the data radio bearer or over a further data radio bearer associated with a further data flow and extracting (409) data from the first and second signals by aggregating the first and second signals.

### FIELD OF THE INVENTION

The invention relates to a system for receiving wireless signals over one or more data radio bearers associated with one or more data flows, a system for establishing data flows located in a mobile communication network, and a base station for transmitting wireless signals to a plurality of devices.

The invention further relates to a method of receiving wireless signals over one or more data radio bearers associated with one or more data flows, a method of establishing data flows, and a method of transmitting wireless signals to a plurality of devices.

The invention also relates to computer program products enabling a computer system to perform such methods.

### BACKGROUND OF THE INVENTION

In state-of-the-art technological implementations, a given UE (User Equipment) operates in a solitary fashion, handling in up- and downlink whatever data traffic it is fed with by higher protocol layers, including the handling of traffic from one or more distinct applications. In case the network is unable to support a given performance requirement (e.g. Guaranteed Bit Rate (GBR) requirement) for a downlink QoS (Quality-of-Service) flow maintained between the UE and the User Plane Function (UPF) in the core network, given the quality of the radio link, then there is effectively no downlink (DL) coverage for that performance requirement (e.g. GBR).

At the 3GPP TSG RAN Meeting #93-e electronic meeting on 13-17 Sep. 2021, Huawei and HiSilicon submitted a document titled “Updated views on Rel-18 UE aggregation” (RP-212282) relating to UE aggregation. UE aggregation was originally raised with the target of improving 5G New Radio uplink performance. UE aggregation can improve uplink (UL) performance through utilizing aggregated resources such as transmit power, antennas and bandwidth. The submission notes that aggregation will also benefit downlink (DL) performance. The submission describes that one key technical aspect for UE aggregation is the anchor point where data is split/duplicated and compares L2 data split/duplication with application layer data split/duplication. Although UE aggregation can be used to increase the attainable DL performance, this does not mean that such higher DL performance can be guaranteed.

### SUMMARY OF THE INVENTION

It is a first objective of the invention to provide systems, which make it possible to establish and support data flows with a downlink QoS requirement that would otherwise not be possible.

It is a second objective of the invention to provide methods, which make it possible to establish and support data flows with a downlink QoS requirement that would otherwise not be possible.

In a first aspect of the invention, a system for receiving wireless signals over one or more data radio bearers associated with one or more data flows comprises a plurality of devices, the plurality of devices including a first device which includes a first wireless receiver and a second device which includes a second wireless receiver and at least one processor configured to determine information relating to each of the plurality of devices and transmit the information to cause a data flow to be requested with one or more quality-of-service requirements and the admittance of the data flow with the one or more quality-of-service requirements to be decided upon based on the information.

The at least one processor is further configured to obtain a first signal received by the first wireless receiver over a data radio bearer associated with the data flow, obtain a second signal received by the second wireless receiver over the data radio bearer or over a further data radio bearer associated with a further data flow, the data flow and the further data flow belonging to the same group of data flows, the group of data flows being associated with one or more joint quality-of-service requirements, and extract data from the first and second signals by aggregating the first and second signals.

One or more processors of the at least one processor may be included in the first device. One or more processors of the at least one processor may be included in the second device. The plurality of devices may comprise more than two devices. Each device may comprise a wireless transmitter in addition to the wireless receiver. The wireless receiver and the wireless transmitter may be combined in a wireless transceiver. Each device may be a UE as referred to in mobile communication standards. The system for receiving wireless signals may be a device itself. In this case, the first and second devices may be components of this device. The first and second signals may be different receptions of the same transmitted signal or receptions of different transmitted signals. The first and second wireless signals may be demodulated after aggregation or may be demodulated separately before aggregation. The data flows may be 5G QoS flows, for example.

By using two wireless receivers, downlink performance may be improved. In order to ensure that this also means that a downlink QoS requirement may be met that would otherwise not be possible, the information relating to each of the plurality of devices is transmitted. This information may then be used by a system for establishing data flows located in a mobile communication network to determine whether the one or more quality-of-service requirements can be accepted considering the downlink performance gain that may be realized. The system for establishing data flows may be, for example, part of the radio access network, e.g., the base station(s), or part of the core network, e.g., the Policy Control Function (PCF), or a combination of both.

The information may include channel state information and/or device information, for example. The device information may specify a quantity of the plurality of devices and/or capabilities of the plurality of devices and/or device identifiers of the plurality of devices, for example. The downlink performance gain may depend, for example, on the number of involved UEs, the number of available receive antennas at each UE, and the degree of correlation of the radio channels towards the involved UEs and receive antennas. In a simple implementation, a fixed mapping of the numbers of UEs and receive antennas to a percentual performance, e.g. throughput, gain may be applied.

In another implementation, the information may be used to calculate whether the use of techniques like receive diversity, enhanced Single User Multiple-Input Multiple-Output (SU-MIMO) beamforming, multi-user diversity, Multi-User Multiple-Input Multiple-Output (MU MIMO), or carrier aggregation improves downlink performance. For example, if devices support carrier aggregation, downlink performance may be improved. Ideally, all available carriers can be assigned to a single device. If this is not possible, by using multiple devices, all available carriers may be utilized, thereby improving downlink performance.

The at least one processor may be configured to determine beamforming feedback based on the reception of one or more reference signals by the first wireless receiver and the reception of the one or more reference signals and/or one or more further reference signals by the second wireless receiver, determine channel state information which includes the beamforming feedback, and transmit the information including the channel state information. The channel state information normally further comprises a channel quality indicator, referred to as CQI, and part of the CSI report, in LTE and 5G. The beamforming feedback may further comprise a rank indicator, referred to as RI, and part of the CSI report, in LTE and 5G.

The beamforming feedback may include first beamforming feedback determined based on the reception of the one or more reference signals by the first wireless receiver and second beamforming feedback determined based on the reception of the one or more reference signals and/or the one or more further reference signals by the second wireless receiver or may include combined beamforming feedback determined based on the reception of the one or more reference signals by the first wireless receiver and the reception of the one or more reference signals by the second wireless receiver.

In a first implementation, the antenna(s) of the first device and the antenna(s) of the second device are regarded as antennas of a single device and channel state information, including beamforming feedback, is determined on this basis. In a second implementation, the second device feeds the first device with its own channel state information and the first device integrates this channel state information with its own channel information and then includes it in the information to be transmitted. In a third implementation, the first device and the second device transmit their channel information independently. In the first two implementations, the system for establishing data flows may not be aware that wireless signals transmitted over a data radio bearer associated with the data flow will be received by multiple devices and then aggregated.

Not only beamforming feedback may be combined but also other parts of the channel state information. The combined channel state information may not only be used for deciding the admittance of a data flow with one or more quality-of-service requirements but may also be used in the phase when the established flows are being handled, i.e. the data transfer phase. The combined channel state information may even be used for this purpose when it is not used for deciding the admittance of a data flow with one or more quality-of-service requirements.

In a second aspect of the invention, a system for establishing data flows located in a mobile communication network comprises at least one processor configured to receive, from a further system, a request to admit at least one data flow with one or more quality-of-service requirements, the at least one data flow being intended to be used for transmissions from a base station to a plurality of devices, the request specifying the one or more quality-of-service requirements, obtain, from and/or based on the request, information relating to each of the plurality of devices, determine, based on the information, whether the one or more quality-of-service requirements can be accepted, and transmit, to the further system, a response that the request has been accepted if it is determined that the one or more quality-of-service requirements can be accepted or a response that the request has been rejected otherwise.

The information relating to each of the plurality of devices normally originates from the plurality of devices themselves, as described above, and may be transmitted to the system for establishing data flows by the (end-user) system for receiving wireless signals, e.g. by the devices themselves, or by another system. This information is used by the system for establishing data flows to determine whether the one or more quality-of-service requirements can be accepted considering the downlink performance gain that may be realized.

The request may be a request to admit a group of at least two data flows and the one or more quality-of-service requirements may be one or more joint quality-of-service requirements. This makes it unnecessary to request admittance of data flows with individual quality-of-service requirements, which would either result in lower admitted quality-of-service requirements or a time-consuming iterative trial-and-error approach. Moreover, joint quality-of-service requirements make it possible to perform scheduling at the base station based on joint quality-of-service requirements rather than individual (data flow-specific) quality-of-service requirements.

The request may specify a joint guaranteed bit rate requirement and/or a joint guaranteed latency requirement and/or a joint guaranteed reliability requirement, for example. The request may comprise the device identifiers of the plurality of devices or a flag which allows the system to obtain the device identifiers of the plurality of devices, for example. The flag uniquely identifies the group of data flows and/or the plurality of devices.

The information may include channel state information relating to each of the plurality of devices and the at least one processor may be configured to determine, based on the channel state information, a correlation between a channel of a first device and a channel of a second device of the plurality of devices, estimate based on the correlation to what degree the first and second devices can be co-scheduled on the same time-frequency resources, and determine whether the one or more joint quality-of-service requirements can be accepted in dependence on the degree to which the first and second devices can be co-scheduled on same time-frequency resources. For example, the aggregate cell-level throughput may be increased under certain circumstances when MU-MIMO is applied, e.g. when the channels of co-scheduled UEs are sufficiently uncorrelated and the respective SINRs are sufficiently high.

The information may further include further channel state information relating to a further device, the further device not being included in the plurality of devices, and the at least one processor may be configured to determine, based on the further channel state information, a further correlation between a channel of a device of the plurality of devices and a channel of the further device, estimate based on the further correlation to what degree the device and the further device can be co-scheduled on the same time-frequency resources, and determine whether the one or more quality-of-service requirements can be accepted in dependence on the degree to which the device and the further device can be co-scheduled on same time-frequency resources.

In a third aspect of the invention, a system for establishing data flows located in a mobile communication network includes at least one processor configured to receive, from a further system in the mobile communication network, a request to admit a group of at least two data flows with one or more joint quality-of-service requirements, the request specifying the one or more joint quality of service requirements, the at least two data flows being intended to be used for transmissions from a base station to a plurality of devices, determine whether the one or more joint quality-of-service requirements can be accepted, and transmit, to the further system, a response that the request has been accepted if it is determined that the one or more joint quality-of-service requirements can be accepted or a response that the request has been rejected otherwise.

The (end-user) system for receiving wireless signals, the system for establishing data flows (located in the mobile communication network), or another system may be configured to select how many data flows it would like to be used for receiving data. If the (end-user) system for receiving wireless signals decides that it would like one data flow to be used, then the system for establishing data flows does not need to be aware that multiple devices, e.g. UEs, of the (end-user) system for receiving wireless signals are involved.

The decision how many data flows a system would like to be used for receiving data may be made based on the information relating to each of the plurality of devices, i.e. the same information that is used by the system for establishing data flows to determine whether the one or more quality-of-service requirements can be accepted. In the end, the admission decision is made by the flow establishment system. If another system than the flow establishment system selects how many devices (and which devices if applicable) and/or how many data flows it would like to be used for receiving data, it may indicate this in its request to the flow establishment system, which may then decide to accept or reject this request.

In a fourth aspect of the invention, a base station for transmitting wireless signals to a plurality of devices comprises at least one processor configured to allocate resources, based on one or more joint quality-of-service requirements, to transmitting a first wireless signal from the base station to a first device over a data radio bearer associated with a data flow, the data flow and at least a further data flow belonging to the same group of data flows, the group of data flows having been assigned the one or more joint quality-of-service requirements, transmit the first wireless signal to the first device over the data radio bearer at a first moment and/or over a first frequency resource, allocate resources, based on the one or more joint quality-of-service requirements, to transmitting a second wireless signal from the base station to a second device over a further data radio bearer associated with the further data flow, and transmit the second wireless signal to the second device over the further data radio bearer at a second moment other than the first moment and/or over a second frequency resource other than the first frequency resource.

The scheduler of this base station schedules downlink resources for data flows with joint quality-of-service requirements and typically also schedules downlink resources for data flows with individual quality-of-service requirements. When scheduling downlink resources for data flows with joint quality-of-service requirements, no individual quality-of-service requirements need to be taken into account. Advantageously, the scheduler of this base station has substantially more freedom when aiming for a single joint quality-of-service (e.g., GBR) requirement than when aiming for multiple individual quality-of-service targets. This enhanced degree of freedom likely translates to diversity gains, hence improved spectral efficiency and hence cell capacity, which may in turn lead to an improved admission probability.

The at least one processor may be configured to determine whether to allocate certain resources to transmitting the first wireless signal to the first device or to transmitting the second wireless signal to the second device based on a first channel quality associated with the first device and a second channel quality associated with the second device. The channel qualities may be determined based on channel state information, e.g. based on CQIs included in CSI reports.

The at least one processor may be configured to decide whether to terminate the data flow or the further data flow, and terminate the data flow or the further data flow and transmit a message to a further system to inform the further system that the data flow or the further data flow of the group of data flows has been or will be terminated if the decision is made to terminate the data flow or the further data flow. The further system may be the (end-user) system for receiving wireless signals or the system for establishing data flows (located in the mobile communication network), for example. This allows the further system to select an additional device, e.g. UE, and/or decide whether an additional data flow is to be requested. For example, if the decision of flow termination is lack of diversity gain, a different device/UE in the group of devices/UEs for which data flows are to be requested may be selected.

The at least one processor may be configured to allocate excess resources fairly between the group of data flows and ungrouped data flows and other groups of data flows. Within a particular group of data flows, resources do not need to be allocated fairly. The excess resources may be resources on top of a GBR level, for example. For instance, if the scheduler is serving stand-alone flow A and flow group B (comprising flows B1 and B2), than the fairness notion is to be addressed at the A vs B level, not at the A vs B1 vs B2 level.

In a fifth aspect of the invention, a method of receiving wireless signals over one or more data radio bearers associated with one or more data flows includes determining information relating to each of a plurality of devices, the plurality of devices including a first device which includes a first wireless receiver and a second device which includes a second wireless receiver, transmitting the information to cause a data flow to be requested with one or more quality-of-service requirements and the admittance of the data flow with the one or more quality-of-service requirements to be decided upon based on the information, obtaining a first signal received by the first wireless receiver over a data radio bearer associated with the data flow, obtaining a second signal received by the second wireless receiver over the data radio bearer or over a further data radio bearer associated with a further data flow, the data flow and the further data flow belonging to the same group of data flows, the group of data flows being associated with one or more joint quality-of-service requirements, and extracting data from the first and second signals by aggregating the first and second signals. The method may be performed by software running on a programmable device. This software may be provided as a computer program product.

In a sixth aspect of the invention, a method of establishing data flows includes receiving a request to admit at least one data flow with one or more quality-of-service requirements, the at least one data flow being intended to be used for transmissions from a base station to a plurality of devices, the request specifying the one or more quality-of-service requirements, obtaining, from and/or based on the request, information relating to each of the plurality of devices, determining, based on the information, whether the one or more quality-of-service requirements can be accepted, and transmitting a response that the request has been accepted if it is determined that the one or more quality-of-service requirements can be accepted or a response that the request has been rejected otherwise. The method may be performed by software running on a programmable device. This software may be provided as a computer program product.

In a seventh aspect of the invention, a method of establishing data flows includes receiving, from a system in the mobile communication network, a request to admit a group of at least two data flows with one or more joint quality-of-service requirements, the request specifying the one or more joint quality of service requirements, the at least two data flows being intended to be used for transmissions from a base station to a plurality of devices, determining whether the one or more joint quality-of-service requirements can be accepted, and transmitting, to the system, a response that the request has been accepted if it is determined that the one or more joint quality-of-service requirements can be accepted or a response that the request has been rejected otherwise. The method may be performed by software running on a programmable device. This software may be provided as a computer program product.

In an eighth aspect of the invention, a method of transmitting wireless signals to a plurality of devices includes allocating resources, based on one or more joint quality-of-service requirements, to transmitting a first wireless signal from the base station to a first device over a data radio bearer associated with a data flow, the data flow and at least a further data flow belonging to the same group of data flows, the group of data flows having been assigned the one or more joint quality-of-service requirements, transmitting the first wireless signal to the first device over the data radio bearer at a first moment and/or over a first frequency resource, allocating resources, based on the one or more joint quality-of-service requirements, to transmitting a second wireless signal from the base station to a second device over a further data radio bearer associated with the further data flow, and transmitting the second wireless signal to the second device over the further data radio bearer at a second moment other than the first moment and/or over a second frequency resource other than the first frequency resource. The method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations for receiving wireless signals over one or more data radio bearers associated with one or more data flows.

The executable operations comprise determining information relating to each of a plurality of devices, the plurality of devices including a first device which includes a first wireless receiver and a second device which includes a second wireless receiver, transmitting the information to cause a data flow to be requested with one or more quality-of-service requirements and the admittance of the data flow with the one or more quality-of-service requirements to be decided upon based on the information, obtaining a first signal received by the first wireless receiver over a data radio bearer associated with the data flow, obtaining a second signal received by the second wireless receiver over the data radio bearer or over a further data radio bearer associated with a further data flow, the data flow and the further data flow belonging to the same group of data flows, the group of data flows being associated with one or more joint quality-of-service requirements, and extracting data from the first and second signals by aggregating the first and second signals.

A non-transitory computer-readable storage medium stores at least a second software code portion, the second software code portion, when executed or processed by a computer, being configured to perform executable operations for establishing data flows.

The executable operations comprise receiving, from a further system in the mobile communication network, a request to admit at least one data flow with one or more quality-of-service requirements, the at least one data flow being intended to be used for transmissions from a base station to a plurality of devices, the request specifying the one or more quality-of-service requirements, obtaining, from and/or based on the request, information relating to each of the plurality of devices, determining, based on the information, whether the one or more quality-of-service requirements can be accepted, and transmitting, to the further system, a response that the request has been accepted if it is determined that the one or more quality-of-service requirements can be accepted or a response that the request has been rejected otherwise.

A non-transitory computer-readable storage medium stores at least a third software code portion, the third software code portion, when executed or processed by a computer, being configured to perform executable operations for establishing data flows.

The executable operations comprise receiving, from a further system in the mobile communication network, a request to admit a group of at least two data flows with one or more joint quality-of-service requirements, the request specifying the one or more joint quality of service requirements, the at least two data flows being intended to be used for transmissions from a base station to a plurality of devices, determining whether the one or more joint quality-of-service requirements can be accepted, and transmitting, to the further system, a response that the request has been accepted if it is determined that the one or more joint quality-of-service requirements can be accepted or a response that the request has been rejected otherwise.

A non-transitory computer-readable storage medium stores at least a fourth software code portion, the fourth software code portion, when executed or processed by a computer, being configured to perform executable operations for transmitting wireless signals to a plurality of devices.

The executable operations comprise allocating resources, based on one or more joint quality-of-service requirements, to transmitting a first wireless signal from the base station to a first device over a data radio bearer associated with a data flow, the data flow and at least a further data flow belonging to the same group of data flows, the group of data flows having been assigned the one or more joint quality-of-service requirements, transmitting the first wireless signal to the first device over the data radio bearer at a first moment and/or over a first frequency resource, allocating resources, based on the one or more joint quality-of-service requirements, to transmitting a second wireless signal from the base station to a second device over a further data radio bearer associated with the further data flow, and transmitting the second wireless signal to the second device over the further data radio bearer at a second moment other than the first moment and/or over a second frequency resource other than the first frequency resource.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method of receiving wireless signals;

FIG. 2 is a flow diagram of an embodiment of the method of establishing data flows;

FIG. 3 is a flow diagram of a second embodiment of the method of receiving wireless signals;

FIG. 4 is a flow diagram of a third embodiment of the method of receiving wireless signals and a first embodiment of the method of transmitting wireless signals to a plurality of devices;

FIG. 5 is a flow diagram of a fourth embodiment of the method of receiving wireless signals and a second embodiment of the method of transmitting wireless signals to a plurality of devices;

FIG. 6 is a block diagram of a first embodiment of the end-user system and a first embodiment of the flow establishment system;

FIG. 7 shows an example of a scenario in which the systems depicted in FIG. 6 may be used;

FIG. 8 shows a first example of flows handled by implementations of the systems depicted in FIG. 6;

FIG. 9 shows a second example of flows handled by implementations of the systems depicted in FIG. 6;

FIG. 10 shows a third example of flows handled by implementations of the systems depicted in FIG. 6;

FIG. 11 shows a fourth example of flows handled by implementations of the systems depicted in FIG. 6;

FIG. 12 is a block diagram of a second embodiment of the end-user system and a second embodiment of the flow establishment system in which the flow establishment system is a base station;

FIG. 13 shows an example of flows handled by implementations of the systems depicted in FIG. 12;

FIG. 14 is a block diagram of the first embodiment of the end-user system and a third embodiment of the flow establishment system;

FIG. 15 shows an example of flows handled by implementations of the systems depicted in FIG. 14;

FIG. 16 is a block diagram of the first embodiment of the end-user system, the first embodiment of the flow establishment system, and a first embodiment of the base station;

FIG. 17 is a block diagram of the second embodiment of the end-user system, a second embodiment of the base station, and a fourth embodiment of the flow establishment system, in which the base station is the flow establishment system; and

FIG. 18 is a block diagram of an exemplary data processing system for performing the methods of the invention.

Corresponding elements in the drawings are denoted by the same reference numeral.

### DETAILED DESCRIPTION OF THE DRAWINGS

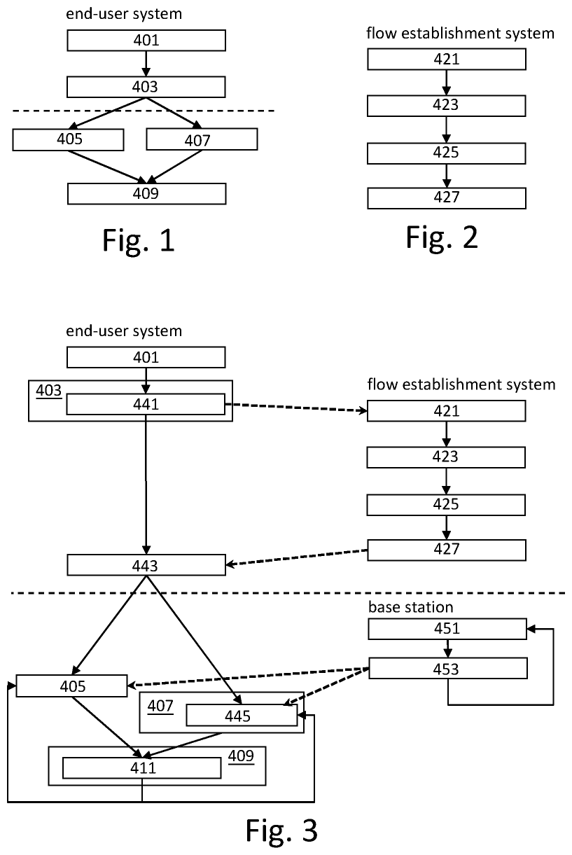

A first embodiment of the method of receiving wireless signals over one or more data radio bearers associated with one or more data flows is shown in FIG. 1. A step 401 comprises determining information relating to each of a plurality of devices. The plurality of devices includes a first device which includes a first wireless receiver and a second device which includes a second wireless receiver. The information may include channel state information and/or device information, for example. The device information may specify one or more of: a quantity of the plurality of devices, capabilities of the plurality of devices, and device identifiers of the plurality of devices, for example.

A step 403 comprises transmitting the information to cause a data flow to be requested with one or more quality-of-service requirements and the admittance of the data flow with the one or more quality-of-service requirements to be decided upon based on the information. Optionally, a second data flow is requested in step 403. Steps 401 and 403 are part of the flow establishment phase.

A step 405 comprises obtaining a first signal received by the first wireless receiver over a data radio bearer associated with the data flow. A step 407 comprises obtaining a second signal received by the second wireless receiver over the data radio bearer or over a further data radio bearer associated with the further data flow. In the latter case, the data flow and the further data flow belong to the same group of data flows and the group of data flows is associated with one or more joint quality-of-service requirements. A step 409 comprises extracting data from the first and second signals by aggregating the first and second signals. Steps 405, 407, and 409 are part of the data transfer phase. The plurality of devices may include more than two devices, more than two data flows may be requested and more than two signals may be received.

An embodiment of the method of establishing data flows is shown in FIG. 2. A step 421 comprises receiving a request to admit at least one data flow with one or more quality-of-service requirements. The at least one data flow is intended to be used for transmissions from a base station to a plurality of devices. The request specifies the one or more quality-of-service requirements.

A step 423 comprises obtaining, from and/or based on the request received in step 421, information relating to each of the plurality of devices. The information may include channel state information and/or device information, for example. The device information may specify one or more of: a quantity of the plurality of devices, capabilities of the plurality of devices, and device identifiers of the plurality of devices, for example.

A step 425 comprises determining, based on the information obtained in step 423, whether the one or more quality-of-service requirements can be accepted. A step 427 comprises transmitting a response that the request has been accepted if it is determined in step 425 that the one or more quality-of-service requirements can be accepted or a response that the request has been rejected otherwise.

By using multiple wireless receivers in an end-user system to receive wireless signals and then aggregating the signals obtained from the wireless receivers, downlink performance may be improved. In order to ensure that this also means that a downlink QoS requirement may be met that would otherwise not be possible, the information relating to each of the plurality of devices is transmitted by the end-user system in step 403 and then used by a flow establishment system in step 425 to determine whether the one or more quality-of-service requirements can be accepted considering the downlink performance gain that may be realized.

There are multiple techniques which use multiple wireless receivers to improve downlink performance. The mobile communication network may support one or more of these techniques. Based on the information transmitted by the end-user system in step 403 and obtained by the flow establishment system in step 423, the downlink performance gain of the supported techniques may be estimated. Five examples of techniques which use multiple wireless receivers to improve downlink performance are described below:
Receive diversity—A single device/UE maintains a single QoS flow with the network but a plurality of receive antennas of a plurality of devices listens to the transmitted wireless signals, thereby potentially increasing the S(I)NR and, consequently, the attainable performance. When this technique is supported by the mobile communication network, it may be beneficial for the single device/UE to include combined channel state information (including CQI feedback) in the transmitted information. The combined channel state information is determined based on at least the reception of one or more reference signals by a first wireless receiver and the reception of the one or more reference signals by a second wireless receiver. In the case of receive diversity, the antenna(s) of a first device and the antenna(s) of a second device are regarded as antennas of a single device and the channel state information is determined on this basis. The flow establishment system may not be aware that wireless signals transmitted over a data radio bearer associated with the data flow will be received by multiple devices and then aggregated. For example, it may not be able to distinguish channel state information relating to a single device with four antennas from channel state information relating to two devices with two antennas each. This combined channel state information may also be used in the data transfer phase, even if it is not used in the flow establishment phase.
Enhanced Single User-MIMO beamforming—With this technique, the receive antennas of the second device are not just used as additional receive antennas. Instead, the derivation of the applied downlink precoding (˜beamforming) is explicitly based on channel knowledge towards the expanded set of receive antennas. In an option (i), the second device/UE feeds the first device/UE with its own channel state information and the first device/UE integrates this channel state information with its own channel state information and then includes this combined channel state information in the information that will be used to decide on the admittance of the data flow. The combined channel state information includes combined beamforming feedback. For example, the second device/UE may feed the first device/UE with its own GoB-derived CSI feedback for integration with that of the first device/UE before submitting its feedback. This combined beamforming feedback may also be used in the data transfer phase, even if it is not used in the flow establishment phase. In an option (ii), the first device and the second device transmit their channel state information independently. In option (i), the flow establishment system may not be aware that wireless signals transmitted over a data radio bearer associated with the data flow will be received by multiple devices and then aggregated. Option (ii) is not transparent to the network and the second device/UE would need to establish a signaling connection with the network. In both cases, there would be a single QoS flow. Channel state information may also be collected by the base station. For example, the second device/UE may be required to (also) transmit an uplink SRS signal allowing the base station to estimate the channel towards all receive antennas. This information may also be used to decide on the admittance of the data flow.
Multi-user diversity—Multi-user diversity gain is an increase in throughput achieved when a channel-aware scheduler exploits the fading differences between multiple devices/UEs by e.g. always scheduling the user with the best instantaneous channel quality. The very fact that the scheduler can intelligently choose between multiple users with distinct instantaneous channel qualities brings the gain, hence the term ‘multi-user diversity gain’. With the establishment of an additional QoS flow to a second device/UE, besides the QoS flow maintained with the primary device/UE, the two flows will share the cell's available resources. Although at the per-flow level, this will generally yield a lower throughput than for a traditional single-flow case, due to multi-user diversity gains, the aggregate throughput, summed over both flows, can indeed be increased. The significance of the gain depends on e.g. the lack of correlation of the radio channels towards both devices/UEs. The two QoS flows (i.e. data flows) are assigned one or more joint QoS requirements.
Multi User MIMO—This technique exploits the general potential for MU-MIMO to increase the aggregate cell-level throughput when applied under suitable circumstances (conditions), in particular when channels of co-scheduled devices/UEs are sufficiently uncorrelated and the respective SINRs are sufficiently high. Again multiple QoS flows (i.e. data flows) are assigned one or more joint QoS requirements. There are different scenarios in which MU-MIMO can enhance the throughput of a group of QoS flows with joint QoS requirements involving multiple devices/UEs. In a first situation where cell A serves only collaborating UE1 and UE2, and the UEs satisfy the co-scheduling (MU-MIMO) conditions, then both UEs can be co-scheduled on the same time-frequency resources (with shared transmit power) such that the aggregate throughput on the two QoS flows with joint QoS requirements exceeds what would be achieved in the baseline single-flow case. In a second situation where UE1 and UE2 may perhaps not satisfy the co-scheduling conditions with respect to one another, the MU-MIMO feature may still yield a throughput enhancement for the joint QoS flows, if the primary UE1 and the added (secondary) UE2 can be fruitfully co-scheduled with other UEs in the cell, e.g. UE1 is co-scheduled with UE3 and UE2 is co-scheduled with UE4.
Carrier aggregation—If a given cell supports more carriers than can be jointly assigned to a single device/UE in downlink carrier aggregation mode, then an application may benefit from involving a second device/UE and establish two QoS flows with joint Qos requirements, where both QoS flows can be served on distinct subsets of carriers and the supported application is effectively assigned more resources and consequently achieving a higher aggregate throughput. For example, a cell may have five distinct carriers at its disposal, e.g. a 10 MHz carrier in the 800 MHz band, a 20 MHz carrier in the 1800 MHz band, a 15 MHz carrier in the 2100 MHz band, a 10 MHz FDD carrier in the 2600 MHz band and a 20 MHz TDD carrier in the 2600 MHz band. With an example limitation to three aggregated carriers for a given device/UE, the resource assignment can be increased from e.g. 10+20+10=40 MHz to 10+20+10+15+20=75 MHz. A similar reasoning applies to the limitation of a maximum bandwidth part that can be assigned to a device/UE on a 5G carrier, where again a benefit can be achieved by aggregating different bandwidth parts assigned to collaborating devices/UEs on the same or different carriers.

The performance gain depends on which techniques are supported by the radio access network and may be estimated as part of step 425. The performance gain may be estimated with the help of one or more algorithms or by using machine learning, e.g. one or more neural networks. The flow establishment system may know which techniques are supported by the radio access network, but this is not required, depending on the level at which machine learning is applied. Typically, the flow establishment system does not know which techniques will actually be used by the radio access network for a certain data flow or certain group of data flows.

When multi-user diversity, MU-MIMO, and/or carrier aggregation are supported, it is possible and may be beneficial to establish multiple data/QoS flows with joint QoS requirements to allow a higher aggregate performance to be guaranteed. The aggregate performance guarantee may be managed by the base station as a joint requirement for the multiple data/QoS flows, enabling joint traffic handling (scheduling, beamforming), or the aggregate requirement may be split into multiple data/QoS-flow specific requirements and the resulting data/QoS flows may subsequently be handled in a traditionally individual manner. The former may allow a higher aggregate throughput to be guaranteed and achieved.

To allow the flow establishment system to estimate the performance gain, it may obtain channel state information relating to each of the plurality of devices (and specifically relating to a channel towards a device). This channel state information may be part of the data/QoS flow establishment request, may be part of another message received by the flow establishment system, or may be obtained based on device identifiers, which may be included in the data/QoS flow establishment request.

The flow establishment system may then determine, based on the channel state information, a correlation between a channel of the first device/UE and a channel of the second device/UE of the plurality of devices, estimate based on the correlation to what degree the first and second devices/UEs can be co-scheduled on the same time-frequency resources, and determine whether the one or more joint quality-of-service requirements can be accepted in dependence on the degree to which the first and second devices/UEs can be co-scheduled on same time-frequency resources. The estimated correlation may be a correlation coefficient between 0 and 1, for example. A mapping from correlation coefficient to performance gain may be used to determine whether the one or more joint quality-of-service requirements can be accepted, for example. As described above, the flow establishment system typically cannot know whether the first and second devices/UEs will indeed be co-scheduled on same time-frequency resources by the base station.

When receive diversity and/or enhanced SU-MIMO beamforming are used, a single QoS flow is established with the end-user system. Although the benefit of using multiple data/QOS flows with joint QoS requirements is absent in this case, the estimated gain of receive diversity and/or enhanced SU-MIMO beamforming may be used to guarantee a higher aggregate performance. The above-mentioned channel state information might also be used for this purpose, but this is not required.

In general, the performance gain may be estimated, e.g. as part of step 425, based on, for example, the number of involved devices/UEs, the number of available receive antennas and the degree of correlation of the radio channels towards the involved devices/UEs and receive antennas. In a simple implementation, a fixed mapping of the numbers of device/UEs and receive antennas to a percentual performance, e.g. throughput, gain may be used.

A second embodiment of the method of receiving wireless signals over one or more data radio bearers associated with one or more data flows is shown in FIG. 3. In the embodiment of FIG. 3, a single data/QoS flow is established for both devices of the end-user system.

Step 401 comprises an end-user system determining information relating to each of a plurality of devices of the end-user system. The plurality of devices includes a first device which includes a first wireless receiver and a second device which includes a second wireless receiver. The information may include channel state information and/or device information, for example. The device information may specify one or more of: a quantity of the plurality of devices, capabilities of the plurality of devices, and device identifiers of the plurality of devices, for example.

Step 403 comprises the end-user system transmitting the information to cause a data flow to be requested with one or more quality-of-service requirements and the admittance of the data flow with the one or more quality-of-service requirements to be decided upon based on the information. In the embodiment of FIG. 3, step 403 is implemented by a step 441. Step 441 comprises transmitting a (single) request to admit a (one) data flow with one or more quality-of-service requirements to a flow establishment system. The request comprises at least part of the information relating to each of the devices. In an alternative embodiment, the end-user system transmits the information to another system but the information eventually ends up at the flow establishment system. The information may be transmitted by the first device, by the second device, or by both devices, for example.

Step 421 comprises the flow establishment system receiving the request to admit at least one data flow with one or more quality-of-service requirements. In the embodiment of FIG. 3, the end-user system only transmits a single request to admit one data flow. The data flow is intended to be used for transmissions from a base station to a plurality of devices, i.e. for downlink transmissions. The request specifies the one or more quality-of-service requirements.

Step 423 comprises the flow establishment system obtaining, from and/or based on the request received in step 421, information relating to each of the plurality of devices. The information may include channel state information and/or device information, for example. The device information may specify one or more of: a quantity of the plurality of devices, capabilities of the plurality of devices, and device identifiers of the plurality of devices, for example.

Step 425 comprises the flow establishment system determining, based on the information obtained in step 423, whether the one or more quality-of-service requirements can be accepted. Step 427 comprises the flow establishment system transmitting a response that the request has been accepted if it is determined in step 425 that the one or more quality-of-service requirements can be accepted or a response that the request has been rejected otherwise.

A step 443 comprise the end-user system receiving the response from the flow establishment system. The end-user system performs steps 405, 407, and 409 if the response indicates that the request has been accepted.

After the data flow has been established, a base station transmits a wireless signal over a data radio bearer associated with the data flow. A step 451 comprises allocating resources, based on one or more quality-of-service requirements, to transmitting the wireless signal from the base station to the first device over the data radio bearer. A step 453 comprises transmitting the wireless signal to the first device over the data radio bearer at a first moment and/or over a first frequency resource.

Step 405 comprises the end-user system obtaining a first signal received by the first wireless receiver over the data radio bearer associated with the data flow. In the embodiment of FIG. 3, step 407 of FIG. 1 is implemented by a step 445. Step 445 comprises obtaining a second signal received by the second wireless receiver over the data radio bearer. The first and second signals are different receptions of the wireless signal transmitted by the base station.

Step 409 comprises extracting data from the first and second signals by aggregating the first and second signals. In the embodiment of FIG. 3, step 409 is implemented by a step 411. Step 411 comprises combining the signals before demodulation/decoding. Steps 451 and 453 and steps 405, 407, and 409 may be repeated one or more times.

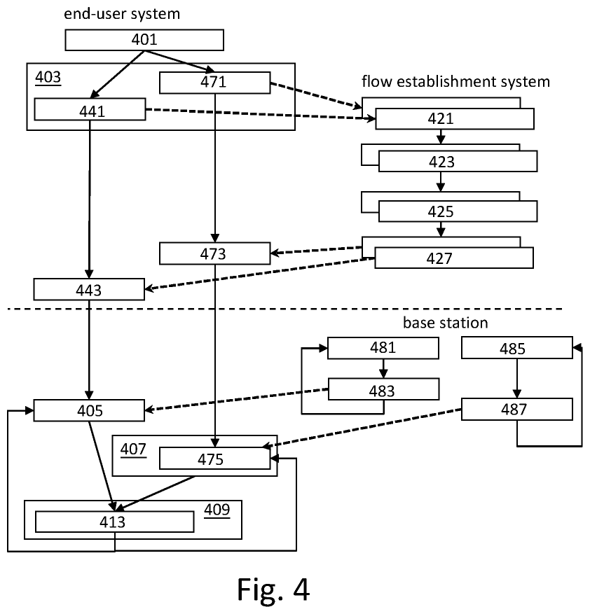

A third embodiment of the method of receiving wireless signals over one or more data radio bearers associated with one or more data flows and a first embodiment of the method of transmitting wireless signals to a plurality of devices are shown in FIG. 4. In the third embodiment of FIG. 4, two data/QoS flows with joint QoS requirements are established for the two devices of the end-user system.

Step 401 comprises the end-user system determining information relating to each of the plurality of devices of the end-user system. The plurality of devices includes a first device which includes a first wireless receiver and a second device which includes a second wireless receiver. The information may include channel state information and/or device information, for example. The device information may specify one or more of: a quantity of the plurality of devices, capabilities of the plurality of devices, and device identifiers of the plurality of devices, for example.

Step 403 comprises the end-user system transmitting the information to cause a data flow to be requested with one or more quality-of-service requirements and the admittance of the data flow with the one or more quality-of-service requirements to be decided upon based on the information. In the embodiment of FIG. 4, step 403 is implemented by steps 441 and 471.

Step 441 comprises the first device of the end-user system transmitting a request to admit a group of two data flows with one or more joint quality-of-service requirements. The request comprises the information determined in step 401. The request is also a request to establish a first data flow of the two data flows. Step 471 comprises the second device of the end-user system transmitting a request to establish a second data flow of the two data flows. Both devices may transmit same or similar requests. Thus, the request to establish the second data flow may also be a request to admit the group of two data flows with the one or more joint quality-of-service requirement. In an alternative embodiment, the end-user system transmits the information to another system but the information eventually ends up at the flow establishment system.

Step 421 comprises the flow establishment system receiving the request or requests to admit the group of two data flows with the one or more joint quality-of-service requirements, including the requests to establish the two data flows. The admission request or requests specify the one or more joint quality-of-service requirements. The data flows are intended to be used for transmissions from a base station to a plurality of devices, i.e. for downlink transmissions.

Step 423 comprises obtaining, from and/or based on the request received in step 421, information relating to each of the plurality of devices. The information may include channel state information and/or device information, for example. The device information may specify one or more of: a quantity of the plurality of devices, capabilities of the plurality of devices, and device identifiers of the plurality of devices, for example.

Step 425 comprises determining, based on the information obtained in step 423, whether the one or more quality-of-service requirements can be accepted. Step 427 comprises transmitting a response to the first device of the end-user system that the request has been accepted if it is determined in step 425 that the one or more quality-of-service requirements can be accepted or a response that the request has been rejected otherwise. If the request has been accepted, step 427 comprises transmitting messages to both devices of the end-user system to thereby establish the two data flows. FIG. 4 does not show what happens if the request has been rejected.

A step 443 comprises the first device of the end-user system receiving the response from the flow establishment system relating to the first data flow. A step 473 comprises the second device of the end-user system receiving the response from the flow establishment system relating to the second data flow. If the data flow admission request(s) transmitted in step 441 is/are rejected before step 471 is performed, steps 471 and 473 might be skipped. The corresponding steps performed by the flow establishment system are then also skipped.

After the data flows have been established, a base station performs steps 481-487. Step 481 comprises the base station allocating resources, based on the one or more joint quality-of-service requirements, to transmitting a first wireless signal from the base station to the first device over a data radio bearer associated with the first data flow. Step 483 comprises the base station transmitting the first wireless signal to the first device over the data radio bearer at a first moment and/or over a first frequency resource.

Step 485 comprises the base station allocating resources, based on the one or more joint quality-of-service requirements, to transmitting a second wireless signal from the base station to the second device over a further data radio bearer associated with the second data flow. Step 487 comprises the base station transmitting the second wireless signal to the second device over the further data radio bearer at a second moment other than the first moment and/or over a second frequency resource other than the first frequency resource.

Optionally, the base station is configured to allocate excess resources fairly between the group of data flows and ungrouped data flows and other groups of data flows. Within a particular group of data flows, resources do not need to be allocated fairly. The excess resources may be resources on top of a GBR level, for example. For instance, if the scheduler is serving stand-alone flow A and flow group B (comprising flows B1 and B2), than the fairness notion is to be addressed at the A vs B level, not at the A vs B1 vs B2 level.

Step 405 comprises obtaining a first signal received by the first wireless receiver over a data radio bearer associated with the first data flow. The first signal is a reception of the first wireless signal transmitted by the base station. In the embodiment of FIG. 4, step 407 of FIG. 1 is implemented by a step 475. Step 475 comprises obtaining a second signal received by the second wireless receiver over the further data radio bearer. The second signal is a reception of the second wireless signal transmitted by the base station. Step 409 comprises extracting data from the first and second signals by aggregating the first and second signals. In the embodiment of FIG. 3, step 409 is implemented by a step 413. Step 413 comprises demodulation/decoding the signals separately and then aggregating the actual data. Steps 481-487 and steps 405, 407, and 409 may be repeated one or more times.

The embodiment of FIG. 3 shows the use of a single data flow and the embodiment of FIG. 4 shows the use of multiple data flows. Whether a single data flow is used or multiple data flows are used may be fixed in the end-user system and/or in the flow establishment system. However, it is also possible to enable the end-user system, the flow-establishment system or another system to select dynamically how many devices/UEs and/or how many data flows it would like to be used for receiving data.

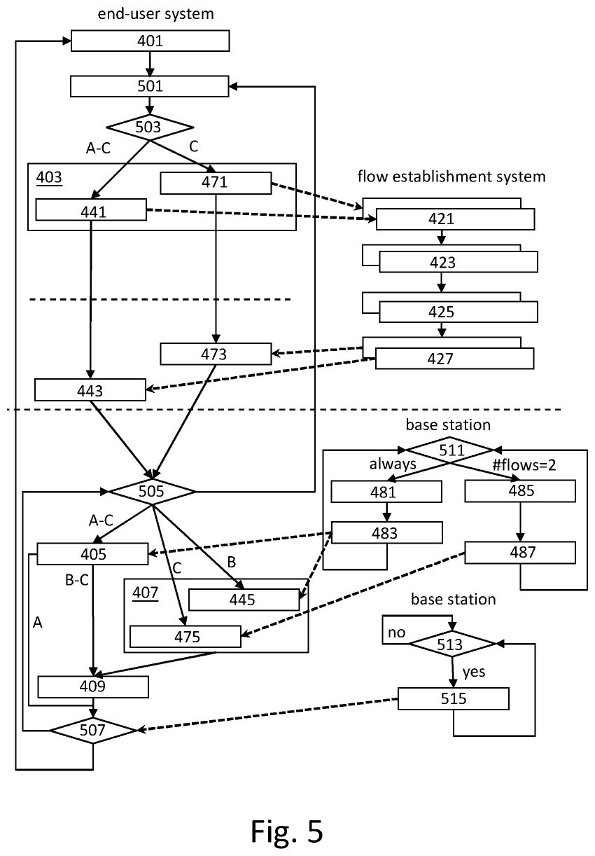

A fourth embodiment of the method of receiving wireless signals over one or more data radio bearers associated with one or more data flows and a second embodiment of the method of transmitting wireless signals to a plurality of devices are shown in FIG. 5.

Step 401 comprises an end-user system determining information relating to each of a plurality of devices of the end-user system. The plurality of devices includes a first device which includes a first wireless receiver and a second device which includes a second wireless receiver. The information may include channel state information and/or device information, for example. The device information may specify one or more of: a quantity of the plurality of devices, capabilities of the plurality of devices, and device identifiers of the plurality of devices, for example.

A step 501 comprises the end-user system deciding, based on the information determined in step 401, how many devices/UEs of the end-user system the end-user system would like to use for receiving data (and if applicable, which devices the end-user system would like to use for receiving the data) and how many data flows the end-user system would like to use for receiving the data. Based on the information (which may be very elaborate or as simple as the number of devices/UEs belonging to the same group), the potential gain on the attainable (joint-) QoS may be estimated, e.g.:
Carrier aggregation/multi-radio dual connectivity: Derive the set of devices/UEs to utilize the full availability of resources at the cell.
MU-Diversity: Estimate how independent (e.g. CQI) the channels between the devices/UEs and the serving base stations are. The more independent the channels are, the higher the potential gain (due to diversity).
MU-MIMO: Cross-correlation of the channels to different devices/UEs (within and outside its own group). The lower the cross-correlation, the higher the potential gain.

The same gain estimation may be performed by the flow-establishment system when determining whether the requested quality-of-service requirements can be accepted.

In the embodiment of FIG. 5, one of three options is selected: A) one device/UE and one data flow, B) two devices/UEs and one data flow, or C) two devices/UEs and two data flows. Next, a step 503 comprises the end-user system determining which steps are to be performed next based on which option was selected in step 501. Steps 441 and 443 of FIGS. 3 and 4 are always performed after step 503. If option C was selected, steps 471 and 473 of FIG. 4 are also performed.

If the admission request was accepted in step 427, and after the data flows have been established, a base station performs steps 481 and 483 of FIGS. 3 and 4 and optionally steps 485 and 487 of FIG. 4. A step 511 comprises determining whether the actual number of established data flows is one or two. Steps 481 and 483 are always performed after step 511.

Steps 485 and 487 are additionally performed if two data flows have been established. In case two flows have been established, these flows are treated knowing that they have a joint QoS requirement so treated as a group. QoS requirement-derived scheduling priorities do not apply within a group but with respect to other devices/UEs outside the group. Other parameters such as link quality may still affect the scheduling priorities within the group.

A step 513 is also performed by the base station, e.g. in parallel with steps 481-487. Step 513 comprises deciding whether to terminate the first data flow or the second data flow, e.g. in case of congestion or if the device grouping is observed to not yield worthwhile gains. For example, in general, while serving the devices/UEs, the network may learn more about the performance gain of serving a group of devices/UEs over serving a sub-group of it. Based on this knowledge, the network may decide to drop one or more flows (one or two flows in the embodiment of FIG. 5). If no data flow is terminated, step 513 is repeated and the method proceeds as shown in FIG. 5. A step 515 is performed if it is decided in step 513 to terminate the first data flow or the second data flow.

Step 515 comprises terminating the first data flow or the second data flow and transmitting a message to the end-user system to inform the end-user system that the first data flow or the second data flow has been or will be terminated. In the embodiment of FIG. 5, the termination message is transmitted to the end-user system in step 515. In an alternative embodiment, this termination message is transmitted to another system, e.g. to the flow establishment system or to the Application Function. Step 513 is repeated after step 515, and the method proceeds as shown in FIG. 5.

A step 505 is performed by the end-user system after step 443 and optionally step 473 has/have been performed by the end-user system. Step 505 comprises the end-user system determining which steps are to be performed next based on which option was selected in step 501 and whether the admission request was accepted or rejected.

If it is determined in step 505 that the admission request was rejected, then step 501 may be repeated and a different option may be selected in the next iteration of step 501, after which the method proceeds as shown in FIG. 5. If two data flows are requested, they are either all admitted or rejected. If the data flow(s) is/are rejected, the flow-establishment system may feedback the reason for rejection (e.g. the requested joint-QoS is too high, or the number of flows are too many) and/or an indication about what is acceptable (e.g. maximum allowed joint-QoS, maximum number of flows).

If the admission is rejected and the reason of rejection is related to the number of flows, then step 501 is repeated as described above. If the reason for rejection is related to the requested QoS, this may be fed back to the application layer for potential adjustments and step 501 or 503 may then be repeated.

If it is determined in step 505 that the admission request was accepted, then at least step 405 is performed. If it is determined in step 505 that option B was selected in step 501, then step 445 of FIG. 3 is additionally performed. If it is determined in step 505 that option C was selected in step 501, then step 475 of FIG. 4 is additionally performed. Step 409 is performed after step 405 and step 445 or 475 have been performed. A step 507 is performed after step 409 has been performed. If option A was selected in step 501, step 409 is skipped and step 507 is performed directly after step 405.

Step 409 comprises extracting data from the first and second signals by aggregating the first and second signals. The aggregation is different if the second signal is obtained over the further data radio bearer than if it is obtained over the data radio bearer, as described in relation to FIGS. 3 and 4.

Step 507 comprises determining whether the base station has terminated any of the data flows. This is more likely if two data flows are being used than if only one data flow is being used. If a data flow has been terminated, the end-user system repeats step 401 and may select a different option in the next iteration of step 501, optionally based on information included in the termination message. If no data flow is terminated, step 505 is repeated and the method proceeds as shown in FIG. 5.

In the embodiment of FIG. 5, it is the end-user system which selects how many devices/UEs (and which devices/UEs if applicable) and/or how many data flows it would like to be used for receiving data, but as described above, alternatively, the flow-establishment system or another system may perform this selection. In the end, the admission decision is made by the flow establishment system. If another system than the flow establishment system selects how many devices/UEs (and which devices/UEs if applicable) and/or how many data flows it would like to be used for receiving data, it may indicate this in its request to the flow establishment system.

In the embodiments of FIGS. 3 to 5, it is the end-user system which transmits one or more requests for a data flow to the flow establishment system, e.g. on instruction of an application server or an application program running on the end-user system. In an alternative embodiment, it is a system in the (core network of the) mobile communication network which transmits these one or more requests, e.g. these one or more requests may be transmitted by or via the Application Function (AF). In the examples of FIGS. 3 to 5, the end-user system comprises and uses two devices/UEs. Alternatively, the end-user system may comprise and use more than two devices/UEs.

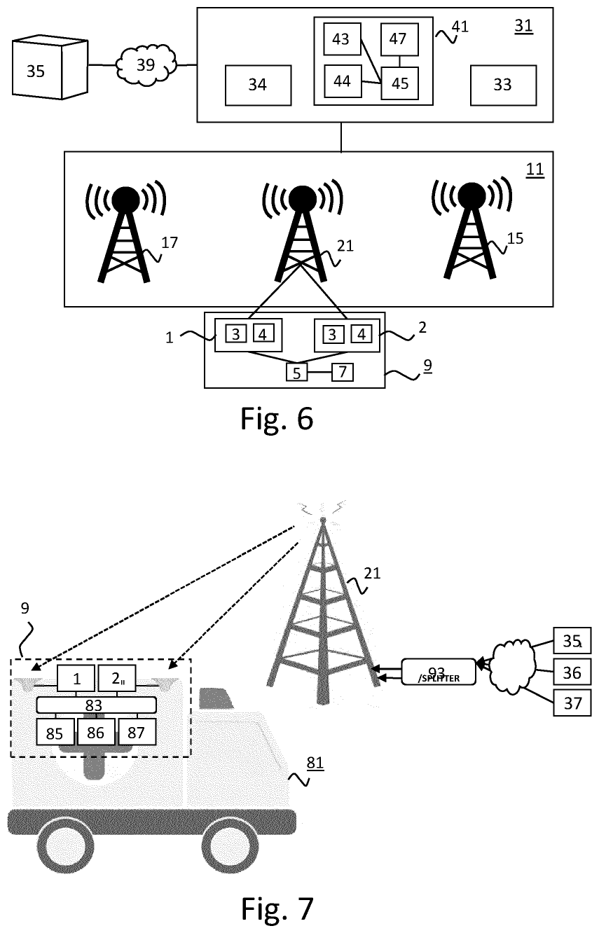

FIG. 6 is a block diagram of a first embodiment of the system for receiving wireless signals over one or more data radio bearers associated with one or more data flows: end-user system 9. The mobile communication network depicted in FIG. 6 comprises a radio access network (RAN) 11 and a core network (CN) 31. The RAN 11 comprises base stations 15, 17, and 21. The mobile communication network may be a 5G network, the RAN 11 may be a 5G New Radio RAN, and the base stations 15, 17, and 21 may be 5G gNodeB base stations, for example. Each of the base stations 15, 17, and 21 may comprise a plurality of distributed units that share a common centralized unit in a Centralized RAN (C-RAN) architecture. The end-user system 9 comprises two devices 1 and 2. These two devices 1 and 2, e.g., 5G UEs, are connected to the base station 21 in the example of FIG. 6. Alternatively, devices 1 and 2 may be connected to different base stations. Devices 1 and 2 may be part of a single apparatus of or may be two apparatus.

The core network 31 comprises a system 41 for establishing data flows. The data flows may be QoS flows, for example. The core network 31 is connected to the Internet 39. An application server 35 is also connected to the Internet. The core network 31 further comprises a system 33 and a system 34. The system 41 may implement the 5G Policy Charging Function (PCF), for example. The system 33 may implement the 5G User Plane Function (UPF), for example. The system 34 may implement the 5G Application Function (AF), for example.

The devices 1 and 2 each comprise a wireless receiver 3 and a wireless transmitter 4. The end-user system 9 further comprises a processor 5 and a memory 7. The processor 5 is configured to determine information relating to device 1 and relating to device 2, transmit the information to cause a data flow to be requested with one or more quality-of-service requirements and the admittance of the data flow with the one or more quality-of-service requirements to be decided upon based on the information. The information may include channel state information and/or device information, for example. The channel state information may comprise beamforming feedback in addition to a channel quality indicator, for example. The device information may specify one or more of: a quantity of the plurality of devices, capabilities of the plurality of devices, and device identifiers of the plurality of devices, for example.

The processor 5 is further configured to obtain a first signal received by the wireless receiver 3 of device 1 over a data radio bearer associated with the data flow, obtain a second signal received by the wireless receiver 3 of the device 2 over the data radio bearer or over a further data radio bearer associated with a further data flow and extract data from the first and second signals by aggregating the first and second signals. The data flow and the further data flow belong to the same group of data flows. The group of data flows is associated with one or more joint quality-of-service requirements. The aggregation is different if the second signal is obtained over the further data radio bearer than if it is obtained over the data radio bearer, as described in relation to FIGS. 3 and 4.

The processor 5 may be configured to determine one or more quality-of-service requirements of one or more applications, e.g., at the (mobile) network level, and create a request to admit a single data flow with one or more quality-of-service requirements or a group of at least two data flows with one or more joint quality-of-service requirements. The quality-of-service requirements may be communicated to the end-user system 9 by an application server 35 or may be determined by an application program running on the end-user system 9, for example. Alternatively, the request to admit a single data flow or a group of data flows may be transmitted by a system in the core network 31.

If the processor 5 would send a request to admit a group of at least two data flows with one or more joint quality-of-service requirements, this request would specify the one or more quality-of-service requirements of the one or more applications as the one or more joint quality-of-service requirements for which admission is requested. The joint nature of the one or more quality-of-service requirements is clear from the request. An example of a joint quality-of-service requirement is a joint GBR requirement (e.g., 100 Mbit/s) for the group of data flows.

The system 41 comprises a receiver 43, a transmitter 44, a processor 45, and a memory 47. The processor 45 is configured to receive, from the end-user system 9 or a from another system in the core network 31, a request to admit at least one data flow with one or more quality-of-service requirements. The at least one data flow is intended to be used for transmissions from a base station, e.g. one or more of base stations 15, 17, and 21, to the devices 1 and 2, i.e. downlink transmissions. The request specifies the one or more quality-of-service requirements. The request may be a request to admit a single data flow with one or more quality-of-service requirements or a group of at least two data flows with one or more joint quality-of-service requirements. If a group of at least two data flows is requested, the same admission request may be transmitted by each of the devices in order to establish each of the at least two data flows.

The processor 45 is further configured to obtain, from and/or based on the request, information relating to each of the plurality of devices. The information may include channel state information and/or device information, for example. The channel state information may comprise beamforming feedback in addition to a channel quality indicator, for example. The device information may specify a quantity of the plurality of devices and/or capabilities of the plurality of devices and/or device identifiers of the plurality of devices, for example. Part or all of this information may be included in the admission request. Further information may be obtained based on device identifiers included in the admission request.

The processor 45 is configured to determine, based on the information, whether the one or more quality-of-service requirements can be accepted and transmit, to the system that transmitted the admission request, a response that the request has been accepted if it is determined that the one or more quality-of-service requirements can be accepted or a response that the request has been rejected otherwise.

The admission request is typically a request to establish the requested data flow or to establish a data flow of the requested group of data flows. Alternatively, the admission request may be separate from, and precede, the flow establishment request(s). If the admission request for a group of data flows is simultaneously a request to establish a data flow of the requested group of data flows, then a request may be transmitted per data flow of the group of data flows and the multiple data flows of the group of data flows are normally either all admitted and established or all rejected and not established.

FIG. 7 shows an example of a scenario in which the end-user system 9 depicted in FIG. 6 may be used. FIG. 7 depicts a scenario in which an ambulance 81 has an in-vehicle local area network served by an on-board access point which itself is attached to the two (distinct) devices 1 and 2, e.g., UEs, through which it connects to the base station 21 in the mobile communication network. The devices 1 and 2 are part of the end-user system 9.

An aggregator 83, functionally located between the application layer and the devices 1 and 2, can aggregate the packet flows to one or more concurrently active applications, e.g., one or more of applications 85-87, over multiple devices, each of which maintaining a data flow (e.g., 5G QOS flow) with the mobile communication network through the base station 21. The aggregator 83 may also function as a splitter in the uplink direction. The aggregator 83 and the one or more of applications 85-87 run on the processor 5 of the end-user system 9.

A splitter 93 resides in or beyond the RAN/core network in order to appropriately extract and aggregate the packet flows of the distinct applications as they are forwarded towards their respective destinations, i.e., application servers 35-37 corresponding to local applications 85-87. The splitter 93 may also function as an aggregator in the uplink direction. In this example, the aggregator 83 and splitter 93 reside outside of the mobile communication network. The devices 1 and 2 have their respective connections with the base station 21. Although FIG. 7 only shows two devices/UEs, more than two devices/UEs may be involved.

In the example of FIG. 7, the applications 85-87 may include one or more GBR-type applications, which are characterized by a minimum (guaranteed) bit rate requirement. In the ambulance scenario this may e.g., involve a real-time video conferencing or ultra-sound session between an ambulance-based paramedic and an expert doctor/surgeon on the hospital premises.

For example, a single GBR-type application may be active, and it may not be possible to satisfy the GBR requirement when the application's packet flow is handled by a single device/UE. This could be because either the GBR requirement is rather demanding or the radio link between the device/UE and the base station is too weak. Traditionally, in such a scenario, the requested data flow would be rejected or the GBR request would be downgraded to a lower level. With the above-described systems, this may be prevented.

By determining, based on information relating to each of the devices that are going to be used to receive the data, whether the one or more quality-of-service requirements can be accepted, the benefit of using techniques like Receive diversity, Enhanced Single User-MIMO beamforming, Multi-user diversity, Multi User MIMO and/or Carrier aggregation may be translated into higher performance guarantees. The use of joint quality-of-service requirements (instead of individual quality-of-service requirements) also allows higher performance guarantees to be made.

With multiple data flows and without joint quality-of-service requirements, the distinct devices/UEs would have to somehow establish data flows with device/UE and data flow-specific GBR that sum up to the aggregate (application-level) GBR of 100 Mb/s. The system requesting admittance of the data flows has no clue whether that should be e.g., a 50/50, a 60/40 or a 70/30 split, since it does not know what kind of quality-of-service requirements the base station and the core network could admit. A 50/50 split could be attempted but it may very well be that the 50 Mb/s GBR request is admitted for one device/UE but not for the other, e.g., because the former has a stronger radio link. In that case, only the former data flow would be admitted and the aggregate GBR is 50+0=50 Mb/s, which is not good enough. It may very well be that in case of e.g., a 60/40 split, both data flows could be admitted, but as said, the system requesting admittance of the data flows has no way of knowing and an iterative trial-and-error approach is time-consuming and far from efficient.

Thus, by using a group of data flows with one or more joint quality-of-service requirements, it is not necessary to request admittance of data flows with individual quality-of-service requirements, which would either result in lower admitted quality-of-service requirements or a time-consuming iterative trial-and-error approach. The above example has been given in relation to (downlink) throughput. However, the same techniques may be used to enhance other performance requirements, e.g., related to latency or reliability.

If the flow establishment system is able to handle groups of data flows with one or more joint quality-of-service requirements, this may be implemented in several ways. The following is a non-exhaustive list of implementation options:
1. In implementation options 1a-c, the one or more joint quality-of-service requirements are split into individual (data flow-specific) quality-of-service requirements involving a procedure to determine/establish that split upon data flow establishment/modification. Once the split is made, the data flows are handled separately in terms of packet scheduling, i.e., in a conventional manner. The individual (data flow-specific) quality-of-service requirements are taken into account by the scheduler.
a) A system in the core network is requested to admit a group of at least two data flows with one or more joint quality-of-service requirements. This system checks whether these one or more joint quality-of-service requirements can be accepted by the core network and by the applicable base station(s). Thus, both the core network and the base station(s) are aware of the joint nature of the one or more quality-of-service requirements of the data flows. The system in the core network is in charge of determining the split. By also letting the base station(s) be aware of the joint nature of the one or more quality-of-service requirements of the data flows, the base station(s) can use this information to perform RAN admission control. The base station(s) may even propose a split. In any case, the base station(s) perform(s) scheduling in a separate, per-flow manner.
b) A base station is requested to admit a group of at least two data flows with one or more joint quality-of-service requirements. The base station is in charge of determining the split. The base station checks whether these individual quality-of-service requirements can be accepted by the core network and whether the base station itself can accept the one or more joint quality-of-service requirements. Alternatively, the base station may check whether it can accept the split individual quality-of-service requirements instead of the joint quality-of-service requirements. In this implementation option 1b, the core network is not aware of the joint nature of the one or more quality-of-service requirements of the data flows.
c) A system in the core network is requested to admit a group of at least two data flows with one or more joint quality-of-service requirements. This system checks whether the one or more joint quality-of-service requirements can be accepted by the core network, and determines a split and checks whether the corresponding individual quality-of-service requirements can be accepted by the applicable base station(s). The base station(s) are not aware of the joint nature of the one or more quality-of-service requirements of the data flows but the system may consult the base station(s) for one or more split options.
2. In implementation options 2a-b, the one or more joint quality-of-service requirements are managed only at the joint level. Since this not only affects admission control but in particular also packet scheduling, the base station needs to know the one or more joint quality-of-service requirements. One key advantage of implementation options 2a-b is that a channel-adaptive scheduler will have substantially more freedom when aiming for a single joint quality-of-service (e.g., GBR) target rather than multiple individual quality-of-service targets. This enhanced degree of freedom likely translates to diversity gains, hence improved spectral efficiency and hence cell capacity, which may in turn lead to an improved admission probability.
a) A system in the core network is requested to admit a group of at least two data flows with one or more joint quality-of-service requirements. Like in option 1a, the system checks whether these one or more joint quality-of-service requirements can be accepted by the core network and by the applicable base station(s). Thus, both the core network and the base station(s) are aware of the joint nature of the one or more quality-of-service requirements of the data flows. However, in option 2a, the scheduler of the base station uses the one or more joint quality-of-service requirements.
b) A base station is requested to admit a group of at least two data flows with one or more joint quality-of-service requirements. The base station checks whether the base station itself can accept the one or more joint quality-of-service requirements, and uses the one or more joint quality-of-service requirements if acceptable, but checks whether individual, rather than joint, quality-of-service requirements can be accepted by the core network. Thus, the core network is not aware of the joint nature of the one or more quality-of-service requirements of the data flows. The individual quality-of-service requirements are only created for the admissibility check with the core network (and possibly for traffic handling within the core network) and not used by the base station itself.

Thus, these implementations are distinct in (i) the awareness of the core network and/or the base station (RAN) regarding the joint nature of the one or more quality-of-service requirements of the data flows (option 1a/2a vs. option 1b/2b vs. option 1c); and (ii) whether the scheduler of the base station manages the quality-of-service requirements at the joint level (option 2a-b) or in an individual (data flow-specific) manner (options 1a-c).

In all the implementation options described above, a response is transmitted indicating that the request has been accepted. In all the implementation options described above, the devices may be served by different base stations. In implementation options 1a, 1c, 2a, and 2b, the different base stations would then normally need to coordinate for admission control of the joint QoS requirements and/or for joint QoS scheduling. If the devices are served by different distributed units of the same base station in a C-RAN architecture, the admission control of the joint QoS requirements and/or the joint Qos scheduling may be performed by the central unit, for example.

FIG. 6 represents implementation option 1a). This implementation option addresses the case where both the base station and the core network are aware of the joint nature of the data flows and scheduling is done in a separate, per-flow manner. In this option, the core network function manages the data flow establishment (in 5G, the PCF manages QoS flow establishment), informs the base station of the joint nature of the data flows, asks the base station for the (admissibility of the) joint quality-of-service requirements (e.g., for the optimal GBR split), checks admissibility from a core network perspective, and then admits (or rejects) and configures the data flows accordingly.

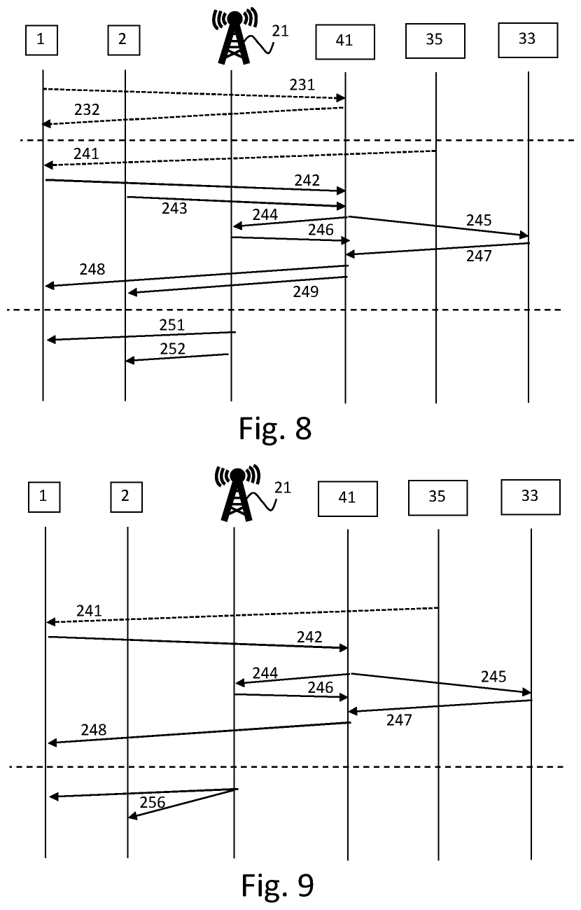

FIG. 8 shows an example of flows handled by implementations of the systems depicted in FIG. 6. In optional step 241, the application server 35 transmits a request to the end-user system 9, via device 1, to setup downlink data flows. In an alternative embodiment, a system in the core network 31, e.g. the Application Function, sets up the downlink data flows instead of the end-user system 9.

In step 242, a request to admit a group of data flows (referred to as QoS flows in 5G) with one or more joint quality-of-service requirements is transmitted by the device 1 to the flow establishment system 41. For example, in case of a 5G network, assuming a PDU session is already active, the device 1 may initiate a PDU Session Modification procedure to create a new GBR QoS flow. It is important that the involved multiple devices are somehow indicated as a group. This grouping information may be available at the devices/UE. Alternatively, the group nature of the multiple devices/UEs may be formulated in the subscription information, e.g. available in the Unified Data Repository (UDR) and managed by the Unified Data Management (UDM) function in a 5G network. This would imply that data/QoS flows are always established and maintained towards the involved devices/UEs as a group.

If the grouping information is available at the devices/UE, the request may comprise device identifiers of the devices in the group, for example. Alternatively, the request may comprise a flag which uniquely identifies the group of data flows, for example. If the request comprises such a flag, it may be obtained in optional steps 231 and 232 preceding step 242.

In step 231, the device 1 transmits a request for a flag to the flow establishment system 41 upon receiving an instruction to do so by higher layer functionality, e.g., an instruction from the aggregator 83 of FIG. 7 or from one of the applications 85-87 of FIG. 7. For example, the application 85 may be controlled by the application server 35 to instruct device 1 in this manner. In step 232, the flow establishment system 41 transmits the flag to the device 1 in response to the request. The device 1 then passes the flag to the higher layer functionality, which can then provide it to devices 1 and 2.

In step 243, a similar request to admit the group of data flows with the one or more joint quality-of-service requirements is transmitted by the device 2 to the flow establishment system 41. Steps 242 and 243 are not just requests to admit the group of data flows but also each comprise a request to establish a respective data flow. In an alternative embodiment, the request or requests to admit the group of data flows is/are separate from the requests to establish the respective data flows. If the request transmitted in step 242 is not the same as the request transmitted in step 243, i.e., specifies different quality-of-service requirements, then both requests may be rejected or a notification of non-matching requests may be issued. In this case, steps 244-247 may be skipped.

In step 244, the flow establishment system 41 asks the base station 21, for example via SMF signaling (the SMF is not depicted in FIG. 6), whether the base station can accept the one or more joint quality-of-service requirements for the group of devices. The flow establishment system 41 identifies the devices of the group of devices in its message to the base station 21. In step 245, the system 41 asks a further system 33 in the core network, e.g. the UPF via SMF signaling, whether the core network can accept the one or more joint quality-of-service requirements.

Steps 244 and 245 are only performed after all requests to admit the group of data flows with the one or more joint quality-of-service requirements have been received by the flow establishment system 41. If these requests comprise device identifiers of devices in the group of devices, then the flow establishment system 41 may wait until requests have been received from these devices. However, the flow establishment system 41 may use a maximum waiting time. This is especially beneficial if devices are able to establish multiple data flows. For example, requests may only be considered to relate to the same group of data flows if the requests are received at around the same time.

If the requests comprise a flag which uniquely identifies the group of data flows, then there is no need to use a maximum waiting time for distinguishing between requests relating to different groups of data flows. However, in order to check with the base station 21 whether the one or more joint quality-of-service requirements can be accepted, all the device identifiers need to be known. The flow establishment system 41 therefore waits until all requests have been received by the flow establishment system 41 before performing steps 244 and 245. If it cannot be determined from the flag how many requests will be transmitted, then a maximum waiting time is used. If this can be determined, it may still be beneficial to use a maximum waiting time. In both cases, the maximum waiting time might be made larger than if the requests do not comprise a flag unique for the group of data flows.

In step 246, the flow establishment system 41 is informed by the base station 21 whether the base station 21 accepts the one or more joint quality-of-service requirements for the group of devices. In step 247, the flow establishment system 41 is informed by the further system 33 whether the core network accepts the one or more joint quality-of-service requirements.

In steps 248 and 249, a response that the request has been accepted (if it is determined that the one or more joint quality-of-service requirements can be accepted) or a response that the request has been rejected is transmitted to the devices 1 and 2, respectively. The same response, i.e., acceptance or rejection, is transmitted to both devices. Whether the one or more joint quality-of-service requirements can be accepted may depend on an estimated benefit of used techniques like Receive diversity, Enhanced Single User-MIMO beamforming, Multi-user diversity, Multi User MIMO and/or Carrier aggregation. This benefit may be estimated based on information related to each of the devices in the group, as described above.

With steps 248 and 249, the respective data flows are established if it is determined that the one or more joint quality-of-service requirements can be accepted. If the request to admit the group of flows has been rejected, the systems may repeat steps 242-247 with one or more reduced joint quality-of-service requirements or with a different set of devices.

In the example of FIG. 8, the base station 21 performs step 251 after the data flow between the core network and device 1 has been established. In step 251, the base station 21 transmits a first wireless signal to device 1 over the data radio bearer associated with this first data flow. The base station 21 performs step 252 after the data flow between the core network and device 2 has been established. In step 252, the base station 21 transmits a second wireless signal to device 2 over the data radio bearer associated with this second data flow.

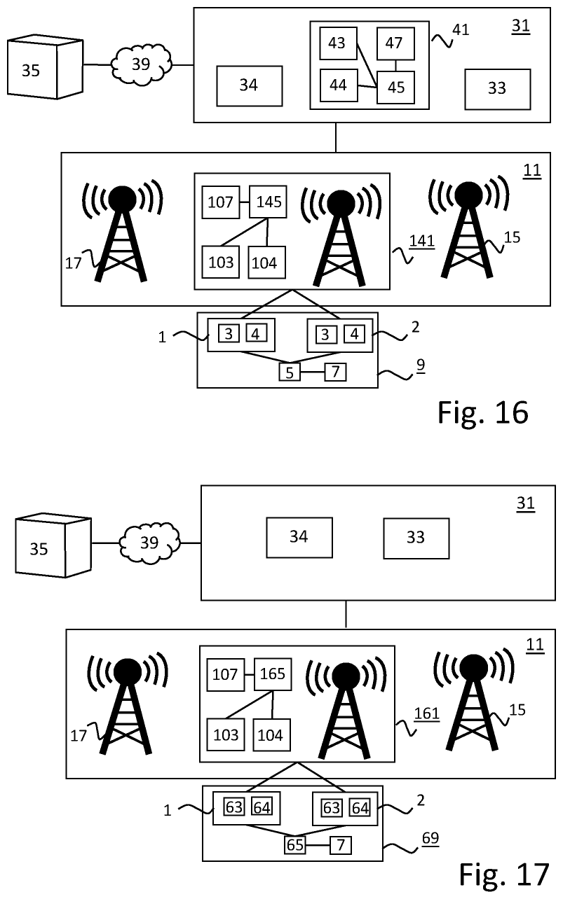

Once the data/QoS flows are established, in the case of a 5G network, a field in the PDU session header (of the UE-specific PDU session under which a UE's QoS flow exists) can be set with e.g. a label ‘group XYZ’, with the same label used in the header of the further UEs' PDU sessions. Via the UPF, these headers pass by the SDAP layer in the base station, where the base station can read the labels and may consequently be aware of the joint nature of the different QoS flows. The base station may then handle the data/QoS flows accordingly, as will described in relation to FIGS. 16 and 17.

In the example of FIG. 8, the end-user system 9 requests admittance of a group of two data flows. In the example of FIG. 9, the end-user system 9 requests admittance of a single data flow, e.g. when only the benefits of receive diversity and/or enhanced SU-MIMO/beamforming are pursued. In the example of FIG. 9, steps 243 and 249 are omitted, as they relate to the second data flow. Furthermore, steps 251 and 252 have been replaced with a step 256.

In step 248, a response that the request has been accepted (if it is determined that the one or more quality-of-service requirements can be accepted) or a response that the request has been rejected is transmitted to the device 1. Whether the one or more quality-of-service requirements can be accepted may depend on an estimated benefit of used techniques like Receive diversity and Enhanced Single User-MIMO beamforming. This benefit may be estimated based on information related to each of the devices in the group, as described above.

The base station 21 performs step 256 after the data flow between the core network and device 1 has been established. In step 256, the base station 21 transmits a wireless signal to device 1 over the data radio bearer associated with this data flow. The device 2 also receives this wireless signal. Steps 231 and 232 may also be performed in this example and in the examples described in the remainder of this description, but have been omitted for the sake of brevity.

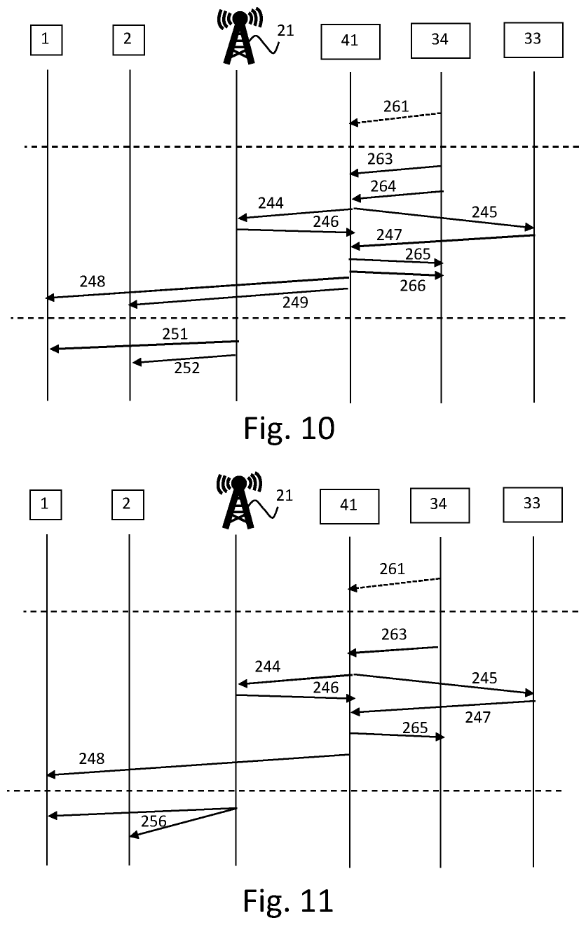

In the examples of FIGS. 8 and 9, it is the end-user system 9 that transmits the admission request(s) to the flow establishment system, e.g. on request by the application server 35. In the example of FIG. 10, it is another system 34 in the core network, e.g. the Application Function (AF) in a 5G network, which transmits the admission request(s).

As mentioned above, it is important that the involved multiple devices are somehow indicated as a group. In the example of FIG. 10, the system 34 is aware that it should establish multiple data/QoS flows to a specific group of devices/UEs, which it will signal to the flow establishment system 41, e.g. the PCF, in step 261. The flow establishment system 41 then further takes care of the joint admission control checks.

Alternatively, this grouping information may be available at the devices/UE. In this case, when the system 34 is establishing a data/QoS flow to support a given application to a given device/UE, the device/UE will know and signal to the network that (always or specifically for that application) further data/QoS flows need to be established to a set of further devices/UEs and that these devices/QoS flows are to be jointly admitted (or blocked) and managed. This is not shown in FIG. 10.

Alternatively, the group nature of the multiple devices/UEs may be formulated in the subscription information, e.g. available in the Unified Data Repository (UDR) and managed by the Unified Data Management (UDM) function in a 5G network. This would imply that data/QoS flows are always established and maintained towards the involved devices/UEs as a group.

In step 263, a request to admit a group of data flows (referred to as Qos flows in 5G) with one or more joint quality-of-service requirements is transmitted by the system 34 to the flow establishment system 41. Step 263 is not just a request to admit the group of data flows but also a request to establish one of the data flows of the group. In step 264, the system 34 transmits a similar request for the second data flow of the group to the flow establishment system 41.

If the request transmitted in step 263 is not the same as the request transmitted in step 264, i.e., specifies different quality-of-service requirements, then both requests may be rejected or a notification of non-matching requests may be issued. In this case, steps 244-247 may be skipped. In an alternative embodiment, steps 263 and 264 may be combined into a single step and a single request may be transmitted.

In the case of a 5G network, assuming a PDU session is already active and addressing the case of a device-terminating (in other words: network-originating) QoS flow: (i) the system 34, e.g. the AF, first submits the flow establishment request to the flow establishment system 41, e.g. the PCF; the flow establishment system 41, e.g. the PCF, acts as the coordinator in the flow establishment and (ii) checks via the SMF with the base station 21 for admissibility from a radio access network perspective and with the further system 33, e.g. the UPF, for admissibility from a core network perspective. As part of the process, the base station 21 may page the targeted device/UE to establish a signaling connection, aiding in the admissibility check.

Steps 244 to 249 and steps 251 and 252 are performed as described in relation to FIG. 8 after steps 263 and 264 have been performed. Additionally, steps 265 and 266 are performed by the flow establishment system 41 to inform the system 34, e.g. the AF in a 5G network, that the two data flows have been established. In an alternative embodiment, steps 265 and 266 may be combined into a single step and a single message may be transmitted.

In the example of FIG. 10, the system 34 requests admittance of a group of two data flows. In the example of FIG. 11, the system 34 requests admittance of a single data flow, e.g. when only the benefits of receive diversity and/or enhanced SU-MIMO/beamforming are pursued. In the example of FIG. 11, steps 264, 266, and 249 are omitted, as they relate to the second data flow. Furthermore, steps 251 and 252 have been replaced with step 256 of FIG. 9.

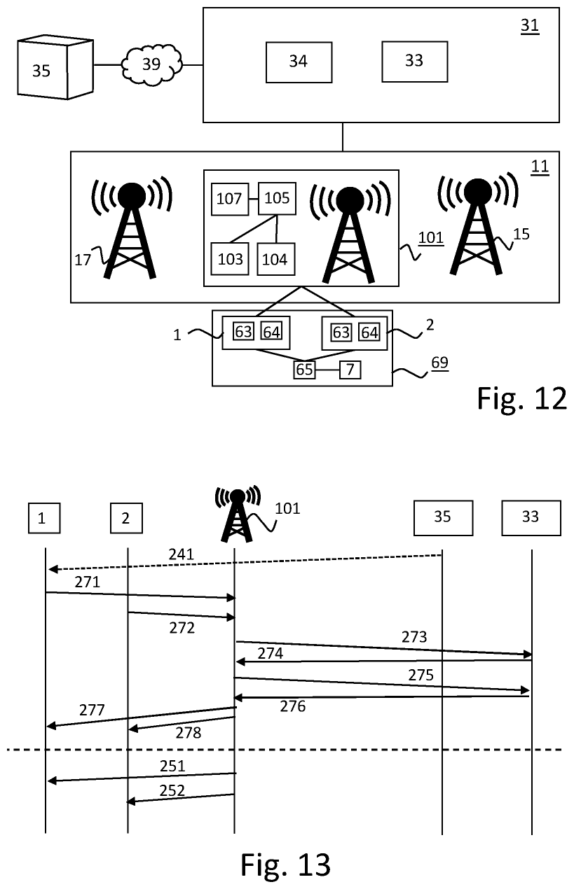

FIG. 12 is a block diagram of a second embodiment of the end-user system and a second embodiment of the flow establishment system in which the flow establishment system is a base station. FIG. 12 represents implementation option 1b). This implementation option addresses the case where only the base station is aware of the joint nature of the data flows and scheduling is done in a separate, per-flow manner. In this implementation option, the (admissibility of the) one or more joint quality-of-service requirements (e.g., the optimal GBR split) is directly determined by the base station based on its knowledge of radio link qualities and the load of the cell where admission is requested, amongst others. There is a check with the core network based on individual (i.e., data flow-specific) quality-of-service requirements (e.g., based on the derived GBR split).

In the embodiment of FIG. 12, the base station 21 of FIG. 6 has been replaced with the base station 101 and the end-user system 9 of FIG. 6 has been replaced with an end-user system 69.

The end-user system 69 comprises devices 1 and 2. The devices 1 and 2 each comprise a wireless receiver 63 and a wireless transmitter 64. The end-user system 69 further comprises a processor 65 and a memory 7. The processor 65 is configured to determine information relating to device 1 and relating to device 2, transmit the information to cause a data flow to be requested with one or more quality-of-service requirements and the admittance of the data flow with the one or more quality-of-service requirements to be decided upon based on the information. The information may include channel state information and/or device information, for example. The channel state information may comprise beamforming feedback in addition to a channel quality indicator, for example. The device information may specify one or more of: a quantity of the plurality of devices, capabilities of the plurality of devices, and device identifiers of the plurality of devices, for example.

The processor 65 is further configured to obtain a first signal received by the wireless receiver 63 of device 1 over a data radio bearer associated with the data flow, obtain a second signal received by the wireless receiver 63 of the device 2 over the data radio bearer or over a further data radio bearer associated with a further data flow and extract data from the first and second signals by aggregating the first and second signals. The data flow and the further data flow belong to the same group of data flows. The group of data flows is associated with one or more joint quality-of-service requirements.

The processor 65 may be configured to determine one or more quality-of-service requirements of one or more applications, e.g., at the (mobile) network level, and create a request to admit a single data flow with one or more quality-of-service requirements or a group of at least two data flows with one or more joint quality-of-service requirements. The quality-of-service requirements may be communicated to the end-user system 69 by an application server 35 or may be determined by an application program running on the end-user system 69, for example. Alternatively, the request to admit a single data flow or a group of data flows may be transmitted from another system in the core network 31.

The base station 101, which also acts as flow-establishment system, comprises a receiver 103, a transmitter 104, a processor 105, and a memory 107. The processor 105 is configured to receive, from the end-user system 69 or a from another system in the core network 31, a request to admit at least one data flow with one or more quality-of-service requirements. The at least one data flow is intended to be used for transmissions from a base station, e.g. one or more of base stations 15, 17, and 101, to the devices 1 and 2, i.e. downlink transmissions. The request specifies the one or more quality-of-service requirements. The request may be a request to admit a single data flow with one or more quality-of-service requirements or a group of at least two data flows with one or more joint quality-of-service requirements.

The processor 105 is further configured to obtain, from and/or based on the request, information relating to each of the plurality of devices. The information may include channel state information and/or device information, for example. The channel state information may comprise beamforming feedback in addition to a channel quality indicator, for example. The device information may specify one or more of: a quantity of the plurality of devices, capabilities of the plurality of devices, and device identifiers of the plurality of devices, for example. Part or all of this information may be included in the admission request. Further information may be obtained based on device identifiers included in the admission request.

The processor 105 is configured to determine, based on the information, whether the one or more quality-of-service requirements can be accepted and transmit, to the system that transmitted the admission request, a response that the request has been accepted if it is determined that the one or more quality-of-service requirements can be accepted or a response that the request has been rejected otherwise.

FIG. 13 shows an example of flows handled by implementations of the systems depicted in FIG. 12. Compared to the flows depicted in FIG. 8, requests are transmitted in steps 271 and 272 to the base station 101 of FIG. 12 instead of in steps 242 and 243 to the flow establishment system 41, as depicted in FIG. 6. Furthermore, the base station 101 does not ask the further system 33, e.g. the UPF, whether the core network can accept the one or more joint quality-of-service requirements. Instead, the base station 101 first splits the one or more joint quality-of-service requirements in individual quality-of-service requirements, e.g., based on its knowledge of radio link qualities and the cell load of the involved devices/UEs, and then asks the further system 33 whether the core network can accept the individual quality-of-service requirements for devices 1 and 2, respectively, in steps 273 and 275, respectively.

The further system 33 informs the base station 101 whether it accepts the individual quality-of-service requirements for devices 1 and 2, respectively, in steps 274 and 276, respectively. In steps 277 and 278, a response that the request has been accepted if it is determined that the one or more joint quality-of-service requirements can be accepted or a response that the request has been rejected otherwise are transmitted by the base station 101 to the devices 1 and 2, respectively. The base station 101 then conducts packet scheduling for both data flows based on the individual (split) quality-of-service requirements.

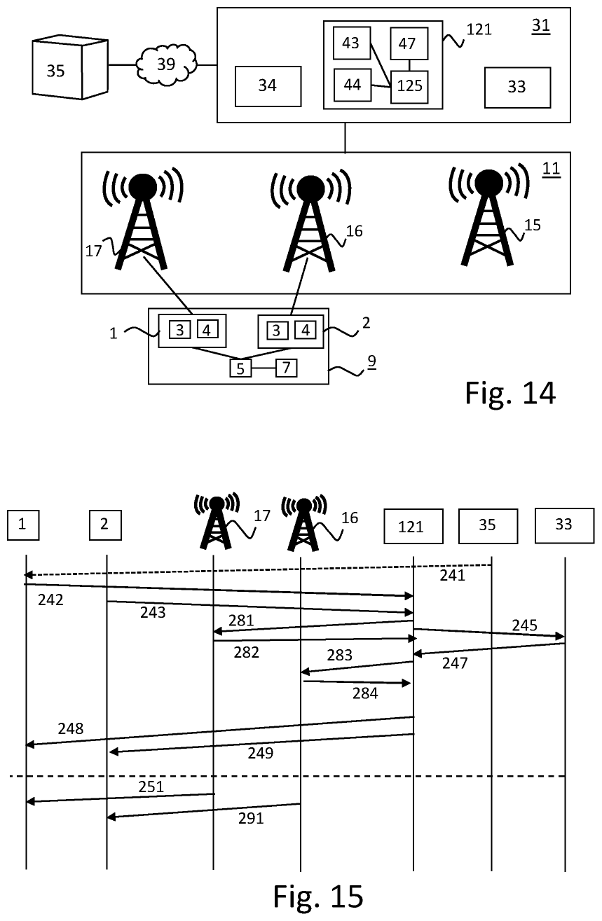

FIG. 14 is a block diagram of the first embodiment of the end-user system (as shown in FIG. 6) and a third embodiment of the flow establishment system. FIG. 14 represents implementation option 1c). This implementation option addresses the case where only the core network 31 is aware of the joint nature of the data flows and scheduling is done in a separate, per-flow manner. In this implementation option, the flow establishment system 121, e.g., the PCF in 5G, determines a suitable split of the joint quality-of-service (e.g., GBR) requirements into individual data flow-specific quality-of-service requirements and ensures that either all or none of the involved data flows (e.g., 5G QOS flows) are established.

The system 121 comprises a receiver 43, a transmitter 44, a processor 125, and a memory 47. The processor 125 is configured to receive, from the end-user system 9 or a from another system in the core network 31, a request to admit at least one data flow with one or more quality-of-service requirements. The at least one data flow is intended to be used for transmissions from a base station, e.g. one or more of base stations 15, 16, and 17 to the devices 1 and 2, i.e. downlink transmissions. The request specifies the one or more quality-of-service requirements. The request may be request to admit a single data flow with one or more quality-of-service requirements or a group of at least two data flows with one or more joint quality-of-service requirements.

The processor 125 is further configured to obtain, from and/or based on the request, information relating to each of the plurality of devices. The information may include channel state information and/or device information, for example. The channel state information may comprise beamforming feedback in addition to a channel quality indicator, for example. The device information may specify a quantity of the plurality of devices and/or capabilities of the plurality of devices and/or device identifiers of the plurality of devices, for example. Part or all of this information may be included in the admission request. Further information may be obtained based on device identifiers included in the admission request.

The processor 125 is configured to determine, based on the information, whether the one or more quality-of-service requirements can be accepted and transmit, to the system that transmitted the admission request, a response that the request has been accepted if it is determined that the one or more quality-of-service requirements can be accepted or a response that the request has been rejected otherwise.

In 5G, the flow establishment system 121 is typically the PCF. The PCF is in control of QoS flows and decides whether the requested GBR is allowed. For this decision, the PCF checks with the gNB via the SMF (for RAN admission control) and checks with UPF via the SMF (for core network admission control). Conventional UPFs will either accept or reject the QoS flow establishment request (depending on the resources availability/capabilities in the core network). Conventional gNBs may be able to use QoS Notification control to revise the request in case the requested QoS cannot be fulfilled due to resource limitations/capabilities at the gNB.

For example, system 121 may successively attempt a number of GBR splits and request admission both in the RAN and the core network, until a split is found for which all data flows are admitted by both RAN and core network. If no such split is found, the core network function rejects the establishment of both data flows.

In the ‘trial and error’ approach of finding an acceptable split, system 121 may optionally request some information from the base stations 16 and 17 that is indicative of e.g., the relative radio link qualities of the involved devices/UEs in order to aid in more quickly finding an optimal split. This may be used instead of or in addition to the above-mentioned QoS Notification control.

In the embodiment of FIG. 14, devices 1 and 2 connect to different base stations, e.g., to distributed units that do not share a common centralized unit in a C-RAN architecture or different base stations in a traditional non-C-RAN architecture, without it being necessary for the different base stations to coordinate in this embodiment. In the example of FIG. 14, device 1 connects to base station 17 and device 2 connects to base station 16. Alternatively, devices 1 and 2 may connect to the same base station, e.g., to the same or to different distributed units that do share a common centralized unit in a C-RAN architecture.

FIG. 15 shows an example of flows handled by implementations of the systems depicted in FIG. 14. Compared to the flows shown in FIG. 8, steps 244 and 246 have been replaced with steps 281-284, because devices 1 and 2 are connected to different base stations. In step 281, the system 121 asks the base station 17 whether the base station can accept the individual (split) quality-of-service requirements for device 1. The base station 17 transmits its response in step 282. In step 283, the system 121 asks the base station 16 whether the base station can accept the individual (split) quality-of-service requirements for device 2. The base station 16 transmits its response in step 284. As described above, steps 281-284 and steps 245 and 247 may be performed several times to find acceptable individual quality-of-service requirements, i.e., an acceptable split.

Since the wireless signals are transmitted to devices 1 and 2 by different base stations, step 252 has been replaced with a step 291. In step 251, the base station 17 transmits a first wireless signal to device 1 over the data radio bearer associated with this first data flow. In step 291, the base station 16 transmits a second wireless signal to device 2 over the data radio bearer associated with this second data flow.

FIG. 16 is a block diagram of the first embodiment of the end-user system (as shown in FIG. 6), the first embodiment of the flow establishment system (as shown in FIG. 6), and a first embodiment of the base station. FIG. 16 represents implementation option 2a). This implementation option addresses the case where both the base station and the core network are aware of the joint nature of groups of data flows and scheduling is done in a joint manner. In this implementation option, the core network can remain in charge of the data flow establishment.

The flow establishment system 41 and the end-user system 9 are the same in this embodiment as in the embodiment of FIG. 6. However, the base station 21 of FIG. 6 has been replaced with a base station 141. The flows shown in FIG. 8 in relation to the embodiment of FIG. 6, and the admission control described in relation to this embodiment, also apply to the embodiment of FIG. 16 with the base station 21 being replaced by the base station 141. Base stations 15 and 17 are the same in the example of FIG. 16 as in the example of FIG. 6, but they may alternatively be replaced with base stations that are configured in the same way as base station 141.

The base station 141 comprises a receiver 103, a transmitter 104, a processor 145, and a memory 107. The processor 145 is configured to allocate resources, based on one or more joint quality-of-service requirements, to transmitting a first wireless signal from the base station 141 to the device 1 over a data radio bearer associated with a data flow and transmit the first wireless signal to the device 1 over the data radio bearer at a first moment and/or over a first frequency resource.

The processor 145 is further configured to allocate resources, based on the one or more joint quality-of-service requirements, to transmitting a second wireless signal from the base station 141 to the device 2 over a further data radio bearer associated with the further data flow and transmit the second wireless signal to the device 2 over the further data radio bearer at a second moment other than the first moment and/or over a second frequency resource other than the first frequency resource.

The data flow and the further data flow belong to the same group of data flows. The group of data flows has been assigned the one or more joint quality-of-service requirements. For example, a joint 100 Mb/s GBR requirement could be satisfied by the base station 141 allocating resources to the devices/UEs such that the sum of their experienced (downlink) throughputs achieves the 100 Mb/s GBR, rather than managing them individually and with rigid individual sub-targets of x Mb/s and (100−x) Mb/s, respectively. The base station 141 is also able to use single data flows, i.e. data flows without joint quality-of-service requirements, in a conventional manner.

FIG. 17 is a block diagram of the second embodiment of the end-user system (as shown in FIG. 12), a second embodiment of the base station (as shown in FIG. 12), and a fourth embodiment of the flow establishment system, in which the base station is the flow establishment system. FIG. 17 represents implementation option 2b). This implementation option addresses the case where only the base station is aware of the joint nature of the data flows and scheduling is done in a joint manner. In this implementation option, the joint admissibility of the data flows is determined by the base station from a RAN perspective and also verified with the core network to cover the core network perspective.

For the latter check, the base station could first split the joint quality-of-service requirements in individual quality-of-service requirements like in the embodiment of FIG. 12., e.g., based on its knowledge of radio link qualities and the cell load of the involved devices/UEs. Once admitted by the core network, the base station may ignore these individual quality-of-service requirements and conduct packet scheduling for both data flows based on the joint (unsplit) quality-of-service requirements.

The base station 161 comprises a receiver 103, a transmitter 104, a processor 165, and a memory 107. The processor 165 is configured in a similar way as the processor 105 of the base station 101 of FIG. 6 with respect to quality-of-service management and configured in a similar way as the processor 145 of the base station 141 of FIG. 16 with respect to scheduling. The flows shown in FIG. 13 in relation to the embodiment of FIG. 12, and the admission control described in relation to this embodiment, also apply to the embodiment of FIG. 16 with the base station 101 being replaced by the base station 161.

While the above description of FIGS. 1 to 17 provides examples in which the applications are characterized by a GBR requirement, the basic principles and implementation options also apply for applications that are characterized by a reliability/latency requirement, where e.g., 99.9999% of all frames, packets or transport blocks need to be successfully transferred within some latency budget. In embodiments where a joint QoS requirement is split into flow-specific QoS requirements, rather than an ‘additive requirement split’, as is the case for Enhanced Mobile Broadband-type (eMBB-type) applications with GBR requirements, a ‘multiplicative requirement split’ may apply for Ultra Reliable and Low Latency Communication-type (URLLC-type) applications with reliability/latency requirements.

For example, in a scenario where block transmissions are duplicated via both data flows, a 99.9999% reliability requirement may be split into two data flow-specific requirements for 99.9% reliability, noting that 0.999999=1−(1−0.999)². Or, alternatively, no such split in reliability requirements is applied, but a common reliability requirement is targeted in a joint management of the two established data flows.

In the embodiments shown in FIGS. 6, 12, 14, 16, and 17, the end-user systems 9 and 69 comprise one processor 5 or 65. In an alternative embodiment, one or more of the end-user systems 9 and 69 comprise multiple processors. One or more of these processors may be part of the devices 1 and 2. The processors 5 and 65 may be general-purpose processors, e.g., ARM or Qualcomm processors, or application-specific processors.

The wireless receivers 3 and 63 and the wireless transmitters 4 and 64 of the devices 1-2 may use one or more wireless communication technologies such as Wi-Fi, LTE, and/or 5G New Radio to communicate with base stations, for example. The receiver and the transmitter may be combined in a transceiver. The end-user system may comprise other components typical for an end-user system, e.g., a battery and/or a power connector.

The devices 1-2 of FIGS. 6, 12, 14, 16, and 17 are also referred to as a mobile device, a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a user equipment (UE), a remote terminal, a handset, a terminal, a user agent, a mobile client, a client, or some other suitable terminology.

In the embodiments shown in FIGS. 6, 14, and 16, the systems 41 and 121 comprises one processor 45 or 125. In an alternative embodiment, the systems 41 and 121 comprise multiple processors. The processor may be a general-purpose processor, e.g., an Intel or an AMD processor, or an application-specific processor, for example. The processor may comprise multiple cores, for example. The processor may run a Unix-based or Windows operating system, for example. The memory 47 may comprise solid state memory, e.g., one or more Solid State Disks (SSDs) made out of Flash memory, or one or more hard disks, for example.

The receiver 43 and the transmitters 44 may use one or more communication technologies (wired or wireless) to communicate, for example, with other systems in the RAN or in the core network. The receiver and the transmitter may be combined in a transceiver. The systems 41 and 121 may comprise other components typical for a network unit in a mobile communication network, e.g., a power supply.

In the embodiments shown in FIGS. 6, 12, 14, 16, and 17, each of the base stations may comprise a single unit or a central unit and one or multiple distributed units, for example.

In the embodiments shown in FIGS. 12, 16, and 17, the base stations 101, 141, and 161 comprise one processor. In an alternative embodiment, one or more of the base stations 101, 141, and 161 comprise multiple processors. The processor of the base stations 101, 141, and 161 may be a general-purpose processor, e.g., an Intel or an AMD processor, or an application-specific processor, for example. The processor may comprise multiple cores, for example. The processor may run a Unix-based or Windows operating system, for example. The memory 107 may comprise solid state memory, e.g., one or more Solid State Disks (SSDs) made out of Flash memory, or one or more hard disks, for example.

The receiver 103 and the transmitter 104 may use one or more wireless communication technologies such as Wi-Fi, LTE, and/or 5G New Radio to communicate with devices 1-2 for example. The receiver 103 and the transmitters 104 may use one or more communication technologies (wired or wireless) to communicate with other systems in the RAN or in the core network, for example. The receivers and the transmitter may be combined in a transceiver. The base stations may comprise other components typical for a component in a mobile communication network, e.g., a power supply.

Although examples in which a single data flow is established and examples in which the data flow(s) is/are network-originating have only been described with respect to the embodiments shown in FIG. 6, examples can be made in a similar manner for the embodiments shown in FIGS. 12, 14, 16, and 17.

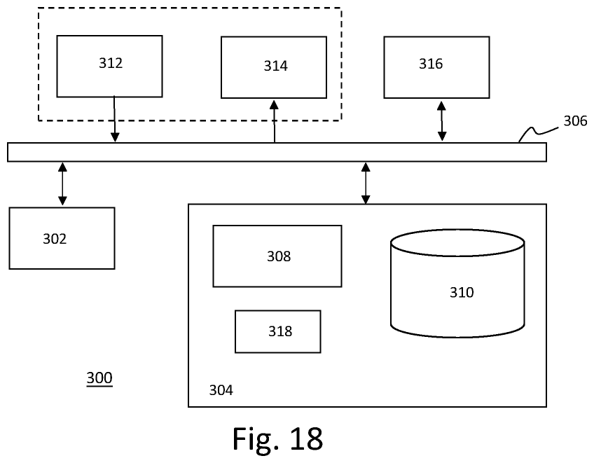

FIG. 18 depicts a block diagram illustrating an exemplary data processing system that may perform the method as described with reference to FIGS. 1-5, 8-11, 13, and 15.

As shown in FIG. 18, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 18 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 18, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 18) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for receiving wireless signals over one or more data radio bearers associated with one or more data flows, the system including:
a plurality of devices, the plurality of devices including a first device which includes a first wireless receiver and a second device which includes a second wireless receiver; and
at least one processor configured to:
determine information relating to each of the plurality of devices,
transmit the information to cause a data flow to be requested with one or more quality-of-service requirements and the admittance of the data flow with the one or more quality-of-service requirements to be decided upon based on the information,
obtain a first signal received by the first wireless receiver over a data radio bearer associated with the data flow,
obtain a second signal received by the second wireless receiver over the data radio bearer or over a further data radio bearer associated with a further data flow, the data flow and the further data flow belonging to the same group of data flows, the group of data flows being associated with one or more joint quality-of-service requirements, and
extract data from the first and second signals by aggregating the first and second signals.

2. A system as claimed in claim 1, wherein the information includes channel state information and/or device information.

3. A system as claimed in claim 2, wherein the information includes device information and the device information specifies a quantity of the plurality of devices and/or capabilities of the plurality of devices and/or device identifiers of the plurality of devices.

4. A system as claimed in claim 1, wherein the at least one processor is configured to determine beamforming feedback based on the reception of one or more reference signals by the first wireless receiver and the reception of the one or more reference signals and/or one or more further reference signals by the second wireless receiver, determine channel state information which includes the beamforming feedback, and transmit the information including the channel state information.

5. A system as claimed in claim 4, wherein the beamforming feedback includes first beamforming feedback determined based on the reception of the one or more reference signals by the first wireless receiver and second beamforming feedback determined based on the reception of the one or more reference signals and/or the one or more further reference signals by the second wireless receiver or includes combined beamforming feedback determined based on the reception of the one or more reference signals by the first wireless receiver and the reception of the one or more reference signals by the second wireless receiver.

6. A system for establishing data flows located in a mobile communication network, the system including at least one processor configured to:
receive, from a further system, a request to admit at least one data flow with one or more quality-of-service requirements, the at least one data flow being intended to be used for transmissions from a base station to a plurality of devices, the request specifying the one or more quality-of-service requirements,
obtain, from and/or based on the request, information relating to each of the plurality of devices,
determine, based on the information, whether the one or more quality-of-service requirements can be accepted, and
transmit, to the further system, a response that the request has been accepted if it is determined that the one or more quality-of-service requirements can be accepted or a response that the request has been rejected otherwise.

7. A system as claimed in claim 6, wherein the request is a request to admit a group of at least two data flows and the one or more quality-of-service requirements are one or more joint quality-of-service requirements.

8. A system as claimed in claim 7, wherein the information includes channel state information relating to each of the plurality of devices and the at least one processor is configured to determine, based on the channel state information, a correlation between a channel of a first device and a channel of a second device of the plurality of devices, estimate based on the correlation to what degree the first and second devices can be co-scheduled on the same time-frequency resources, and determine whether the one or more joint quality-of-service requirements can be accepted in dependence on the degree to which the first and second devices can be co-scheduled on same time-frequency resources.

9. A system as claimed in claim 6, wherein the information further includes further channel state information relating to a further device, the further device not being included in the plurality of devices, and the at least one processor is configured to determine, based on the further channel state information, a further correlation between a channel of a device of the plurality of devices and a channel of the further device, estimate based on the further correlation to what degree the device and the further device can be co-scheduled on the same time-frequency resources, and determine whether the one or more quality-of-service requirements can be accepted in dependence on the degree to which the device and the further device can be co-scheduled on same time-frequency resources.

10. A base station for transmitting wireless signals to a plurality of devices, the base station including at least one processor configured to:
allocate resources, based on one or more joint quality-of-service requirements, to transmitting a first wireless signal from the base station to a first device over a data radio bearer associated with a data flow, the data flow and at least a further data flow belonging to the same group of data flows, the group of data flows having been assigned the one or more joint quality-of-service requirements,
transmit the first wireless signal to the first device over the data radio bearer at a first moment and/or over a first frequency resource,
allocate resources, based on the one or more joint quality-of-service requirements, to transmitting a second wireless signal from the base station to a second device over a further data radio bearer associated with the further data flow, and
transmit the second wireless signal to the second device over the further data radio bearer at a second moment other than the first moment and/or over a second frequency resource other than the first frequency resource.

11. A base station as claimed in claim 10, wherein the at least one processor is configured to:
decide whether to terminate the data flow or the further data flow, and
terminate the data flow or the further data flow and transmit a message to a further system to inform the further system that the data flow or the further data flow of the group of data flows has been or will be terminated if the decision is made to terminate the data flow or the further data flow.

12. A method of receiving wireless signals over one or more data radio bearers associated with one or more data flows, the method including:
determining information relating to each of a plurality of devices, the plurality of devices including a first device which includes a first wireless receiver and a second device which includes a second wireless receiver;
transmitting the information to cause a data flow to be requested with one or more quality-of-service requirements and the admittance of the data flow with the one or more quality-of-service requirements to be decided upon based on the information;
obtaining a first signal received by the first wireless receiver over a data radio bearer associated with the data flow;
obtaining a second signal received by the second wireless receiver over the data radio bearer or over a further data radio bearer associated with a further data flow, the data flow and the further data flow belonging to the same group of data flows, the group of data flows being associated with one or more joint quality-of-service requirements; and
extracting data from the first and second signals by aggregating the first and second signals.

13. A method of establishing data flows, the method including:
receiving a request to admit at least one data flow with one or more quality-of-service requirements, the at least one data flow being intended to be used for transmissions from a base station to a plurality of devices, the request specifying the one or more quality-of-service requirements;
obtaining, from and/or based on the request, information relating to each of the plurality of devices;
determining, based on the information, whether the one or more quality-of-service requirements can be accepted; and
transmitting a response that the request has been accepted if it is determined that the one or more quality-of-service requirements can be accepted or a response that the request has been rejected otherwise.

14. A method of transmitting wireless signals to a plurality of devices, the method including:
allocating resources, based on one or more joint quality-of-service requirements, to transmitting a first wireless signal from the base station to a first device over a data radio bearer associated with a data flow, the data flow and at least a further data flow belonging to the same group of data flows, the group of data flows having been assigned the one or more joint quality-of-service requirements,
transmitting the first wireless signal to the first device over the data radio bearer at a first moment and/or over a first frequency resource,
allocating resources, based on the one or more joint quality-of-service requirements, to transmitting a second wireless signal from the base station to a second device over a further data radio bearer associated with the further data flow, and
transmitting the second wireless signal to the second device over the further data radio bearer at a second moment other than the first moment and/or over a second frequency resource other than the first frequency resource.

15. A computer program or suite of computer programs including at least one software code portion or a computer program product storing at least one software code portion, the software code portion, when run on a computer system, being configured for performing the method of claim 12.
